(19) United States
(12) Patent Application Publication
(10) Pub. No.: US 2021/0243784 A1
(43) Pub. Date: Aug. 5, 2021

(54) TERMINAL APPARATUS

(71) Applicants: SHARP KABUSHIKI KAISHA, Sakai City, Osaka (JP); FG Innovation Company Limited, Tuen Mun, New Territories (HK)

(72) Inventors: JUNGO GOTO, Sakai City, Osaka (JP); OSAMU NAKAMURA, Sakai City, Osaka (JP); SEIJI SATO, Sakai City, Osaka (JP); YASUHIRO HAMAGUCHI, Sakai City, Osaka (JP)

(21) Appl. No.: 17/049,953

(22) PCT Filed: Apr. 26, 2019
(86) PCT No.: PCT/JP2019/017958

§ 371 Date: Oct. 22, 2020

(30) Foreign Application Priority Data
Apr. 27, 2018 (JP) 2018-086485

(51) Int. Cl. H04W 72/12; H04L 1/00

(52) U.S. Cl. CPC H04W 72/1284; H04W 72/1247; H04L 1/001; H04L 1/0004

(57) ABSTRACT

A terminal apparatus includes: a control information detection unit configured to detect RRC information; and a transmitter configured to transmit an SR for requesting a PUSCH resource, wherein a configuration of a PUCCH detected includes multiple configurations for the SR, including at least a first resource used to transmit the SR for transmission of a first transport block and a second resource used to transmit the SR for transmission of a second transport block, an MCS table used for the transmission of the first transport block can specify an MCS with a frequency utilization efficiency lower than a lowest frequency utilization efficiency usable in an MCS table used for the transmission of the second transport block, and the transmitter transmits the SR in the first resource in a case that a higher layer provides at least the first transport block, and transmits the SR in the second resource in a case that the higher layer provides the second transport block.

### TECHNICAL FIELD

The present invention relates to a terminal apparatus.

This application claims priority to JP 2018-086485 filed on Apr. 27, 2018, the contents of which are incorporated herein by reference.

### BACKGROUND ART

In recent years, 5th Generation (5G) mobile telecommunication systems have been focused on, and a communication technology is expected to be specified, the technology establishing MTC mainly based on a large number of terminal apparatuses (Massive Machine Type Communications; mMTC), Ultra-reliable and low latency communications (URLLC), and enhanced Mobile BroadBand (eMBB). The 3rd Generation Partnership Project (3GPP) has been studying New Radio (NR) as a 5G communication technique and discussing NR Multiple Access (MA).

In 5G, Internet of Things (IoT) is expected to be established that allows connection of various types of equipment not previously connected to a network, and establishment of mMTC is an important issue. In 3GPP, a Machine-to-Machine (M2M) communication technology has already been standardized as Machine Type Communication (MTC) that accommodates terminal apparatuses transmitting and/or receiving small size data (NPL 1). Furthermore, in order to support data transmission at a low rate in a narrow band, standardization of Narrow Band-IoT (NB-IoT) has been conducted (NPL 2). 5G is expected to accommodate more terminals than the above-described standards and to accommodate IoT equipment requiring ultra-reliable and low-latency communications.

On the other hand, in communication systems such as Long Term Evolution (LTE) and LTE-Advanced (LTE-A) which are specified by the 3GPP, terminal apparatuses (User Equipment (UE)) use a Random Access Procedure, a Scheduling Request (SR), and the like, to request a radio resource for transmitting uplink data to a base station apparatus (also referred to as a Base Station (BS) or an evolvedNode B (eNB)). The base station apparatus provides uplink grant (UL Grant) to each terminal apparatus based on an SR. In a case that the terminal apparatus receives UL Grant for control information from the base station apparatus, the terminal apparatus transmits uplink data by using a given radio resource (referred to as Scheduled access, grant-based access, or transmissions based on dynamic scheduling, and hereinafter referred to as scheduled access), based on an uplink transmission parameter included in the UL Grant. In this manner, the base station apparatus controls all uplink data transmissions (the base station apparatus knows radio resources for uplink data transmitted by each terminal apparatus). In the scheduled access, the base station apparatus can establish Orthogonal Multiple Access (OMA) by controlling uplink radio resources.

5G mMTC involves a problem in that the use of the scheduled access increases the amount of control information. URLLC involves a problem in that the use of the scheduled access increases delay. Thus, utilization of grant free access (also referred to as grant less access, Contention-based access, Autonomous access, Resource allocation for uplink transmission without grant, type1 configured grant transmission, or the like; hereinafter referred to as grant free access) or Semi-persistent scheduling (also referred to as SPS, Type2 configured grant transmission, or the like) has been studied in which the terminal apparatus transmits data without performing any random access procedure or SR transmission, and without performing UL Grant reception, or the like (NPL 3). In the grant free access, increased overhead associated with control information can be suppressed even in a case that a large number of devices transmit small size data. Furthermore, in the grant free access, no UL Grant reception or the like is performed, and thus the time from generation until transmission of transmission data can be shortened. In the SPS, data transmission is possible by notifying of a portion of the transmission parameters with higher layer control information, and notifying of the transmission parameter not notified by the higher layer in conjunction with the UL Grant of activation indicating the grant of the periodic resource.

On the other hand, in the downlink, the allocated resources for the data transmission of the eMBB can be used for data transmission of the URLLC. The base station apparatus notifies the UE of the destination of the downlink eMBB of the Pre-emption control information, and uses the Pre-emption resource for the data transmission of the downlink URLLC. On the other hand, the terminal apparatus that has detected the Pre-emption control information for the resource for which downlink data reception is scheduled determines that there is no downlink data addressed to the own station in the resource specified by the Pre-emption. Multiplexing of eMBB and URLLC data between different terminal apparatuses in the uplink has been studied. Multiplexing of eMBB and URLLC data has also been studied in a case that one terminal apparatus has eMBB and URLLC traffic.

In a case that data transmission of the eMBB and the URLLC occurs in a single terminal apparatus (Intra-UE), the base station apparatus needs to perform scheduling (allocation of radio resources), retransmission control, and transmission of downlink control information so as to satisfy the requirements of the eMBB and the URLLC.

### CITATION LIST

### Non Patent Literature

NPL 1: 3GPP, TR36.888 V12.0.0, “Study on provision of low-cost Machine-Type Communications (MTC) User Equipments (UEs) based on LTE,” June 2013

NPL 2: 3GPP, TR45.820 V13.0.0, “Cellular system support for ultra-low complexity and low throughput Internet of Things (CIoT),” August 2015

NPL 3: 3GPP, TS38.214 V15.1.0, “Physical layer procedures for data (Release 15),” March 2018

### SUMMARY OF INVENTION

### Technical Problem

In a case that a terminal apparatus has data to be transmitted, the terminal apparatus only requests an uplink grant in a scheduling request (SR) to transmit on a PUCCH, and does not notify of any traffic between eMBB and URLLC. Therefore, even in a case that a base station apparatus receives an SR, there is a problem that the data transmitted by the terminal apparatus cannot be determined either a traffic of the eMBB or a traffic of the URLLC.

One aspect of the present invention has been made in view of such circumstances, and an object of the present invention is to provide a terminal apparatus capable of realizing a determination of whether uplink data requires low delay or high reliability.

### Solution to Problem

To solve the above-mentioned problem, a terminal apparatus according to an aspect of the present invention is configured as follows.

(1) One aspect of the present invention is a terminal apparatus for communicating with a base station apparatus, the terminal apparatus including: a control information detection unit configured to detect RRC information including a configuration of uplink control information; and a transmitter configured to transmit a scheduling request for requesting a resource of an uplink shared channel for data transmission, wherein the configuration of the uplink control information detected by the control information detection unit includes multiple configurations for the scheduling request, including at least a first resource used to transmit the scheduling request for transmission of a first transport block and a second resource used to transmit the scheduling request for transmission of a second transport block, an MCS index table used for the transmission of the first transport block can specify a combination of a modulation order and a coding rate with a frequency utilization efficiency lower than a lowest frequency utilization efficiency usable in an MCS index table used for the transmission of the second transport block, and the transmitter transmits the scheduling request in the first resource in a case that a higher layer provides at least the first transport block, and transmits the scheduling request in the second resource in a case that the higher layer provides the second transport block.

(2) According to one aspect of the present invention, the first resource used to transmit the scheduling request for the transmission of the first transport block is notified by using an ID indicating a set of a PUCCH resource, a PUCCH format, and an SR transmittable periodicity and offset.

(3) According to one aspect of the present invention, the first resource used to transmit the scheduling request for the transmission of the first transport block is notified by using an ID indicating a set of a period of a transmission prohibit timer after transmission of an SR, and a maximum number of SR transmissions.

(4) According to one aspect of the present invention, the transmitter is configured with multiple BWPs or multiple serving cells, and in a case that a plurality of the first resources used to transmit the scheduling request for the transmission of the first transport block are configured, a first resource of the plurality of the first resources used to transmit the scheduling request of an active BWP or an active serving cell is used.

(5) According to one aspect of the present invention, in a case that the plurality of the first resources used to transmit the scheduling request for the transmission of the first transport block are configured, a priority of the first resource used to transmit the scheduling request is also notified.

(6) According to one aspect of the present invention, in the transmission of the first transport block, at least one of following conditions is satisfied: an uplink grant is notified in a DCI format different from that for the transmission of the second transport block; an MCS table different from that for the transmission of the second transport block is used; an MCS having a lower frequency utilization efficiency than an MCS for the transmission of the second transport block can be used; the number of HARQ processes that can be used is less than that for the transmission of the second transport block; and the number of repetitions of an identical data is greater than that for the transmission of the second transport block.

(7) According to one aspect of the present invention, the first resource used to transmit the scheduling request for the transmission of the first transport block is configured by a DCI format.

### Advantageous Effects of Invention

According to one or more aspects of the present invention, an efficient uplink data transmission can be achieved.

### BRIEF DESCRIPTION OF DRAWINGS

FIG. 1 is a diagram illustrating an example of a communication system according to a first embodiment.

FIG. 2 is a diagram illustrating an example of a radio frame structure for the communication system according to the first embodiment.

FIG. 3 is a schematic block diagram illustrating a configuration of a base station apparatus 10 according to the first embodiment.

FIG. 4 is a diagram illustrating an example of a signal detection unit according to the first embodiment.

FIG. 5 is a schematic block diagram illustrating a configuration of a terminal apparatus 20 according to the first embodiment.

FIG. 6 is a diagram illustrating an example of a signal detection unit according to the first embodiment.

FIG. 7 is a diagram illustrating an example of a sequence chart for a conventional uplink data transmission.

FIG. 8 is a diagram illustrating an example of a sequence chart for data transmission of an uplink according to the first embodiment.

FIG. 9 is a diagram illustrating an example of a sequence chart for data transmission of the uplink according to the first embodiment.

FIG. 10 is a diagram illustrating an example of an MCS table for the data transmission of the uplink according to the first embodiment.

FIG. 11 is a diagram illustrating an example of a sequence chart for data transmission of an uplink according to a second embodiment.

FIG. 12 is a diagram illustrating an example of a sequence chart for data transmission of an uplink according to a third embodiment.

### DESCRIPTION OF EMBODIMENTS

A communication system according to the present embodiments includes a base station apparatus (also referred to as a cell, a small cell, a pico cell, a serving cell, a component carrier, an eNodeB (eNB), a Home eNodeB, a Low Power Node, a Remote Radio Head, a gNodeB (gNB), a control station, a Bandwidth Part (BWP), or a Supplementary Uplink (SUL)), and a terminal apparatus (also referred to as a terminal, a mobile terminal, a mobile station, or User Equipment (UE)). In the communication system, in case of a downlink, the base station apparatus serves as a transmitting apparatus (a transmission point, a transmit antenna group, or a transmit antenna port group), and the terminal apparatus serves as a receiving apparatus (a reception point, a reception terminal, a receive antenna group, or a receive antenna port group). In a case of an uplink, the base station apparatus serves as a receiving apparatus, and the terminal apparatus serves as a transmitting apparatus. The communication system is also applicable to Device-to-Device (D2D) communication. In this case, the terminal apparatus serves both as a transmitting apparatus and as a receiving apparatus.

The communication system is not limited to data communication between the terminal apparatus and the base station apparatus, the communication involving human beings, but is also applicable to a form of data communication requiring no human intervention, such as Machine Type Communication (MTC), Machine-to-Machine (M2M) Communication, communication for Internet of Things (IoT), or Narrow Band-IoT (NB-IoT) (hereinafter referred to as MTC). In this case, the terminal apparatus serves as an MTC terminal. The communication system can use, in the uplink and the downlink, a multi-carrier transmission scheme such as Discrete Fourier Transform Spread—Orthogonal Frequency Division Multiplexing (DFTS-OFDM, also referred to as Single Carrier—Frequency Division Multiple Access (SC-FDMA)), and Cyclic Prefix—Orthogonal Frequency Division Multiplexing (CP-OFDM). The communication system can also use Filter Bank Multi Carrier (FBMC), Filtered-OFDM (f-OFDM), Universal Filtered-OFDM (UF-OFDM), or Windowing-OFDM (W-OFDM), to which a filter is applied, a transmission scheme using a sparse code (Sparse Code Multiple Access (SCMA)), or the like. Furthermore, the communication system may apply DFT precoding and use a signal waveform for which the filter described above is used. Furthermore, the communication system may apply code spreading, interleaving, the sparse code, and the like in the above-described transmission scheme. Note that, in the description below, at least one of the DFTS-OFDM transmission and the CP-OFDM transmission is used in the uplink, whereas the CP-OFDM transmission is used in the downlink but that the present embodiments are not limited to this configuration and any other transmission scheme is applicable.

The base station apparatus and the terminal apparatus according to the present embodiments can communicate in a frequency band for which an approval of use (license) has been obtained from the government of a country or region where a radio operator provides services, that is, a so-called licensed band, and/or in a frequency band for which no approval (license) from the government of the country or region is required, that is, a so-called unlicensed band. In the unlicensed band, communication may be based on carrier sense (e.g., a listen before talk scheme).

According to the present embodiments, “X/Y” includes the meaning of “X or Y”. According to the present embodiments, “X/Y” includes the meaning of “X and Y”. According to the present embodiments, “X/Y” includes the meaning of “X and/or Y”. First Embodiment

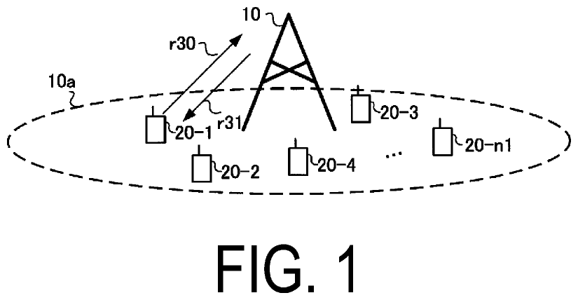

FIG. 1 is a diagram illustrating an example of a configuration of a communication system according to the present embodiment. The communication system according to the present embodiment includes a base station apparatus 10 and terminal apparatuses 20-1 to 20-n1 (n1 is a number of terminal apparatuses connected to the base station apparatus 10). The terminal apparatuses 20-1 to 20-n1 are also collectively referred to as terminal apparatuses 20. Coverage 10a is a range (a communication area) in which the base station apparatus 10 can connect to the terminal apparatus 20 (coverage 10a is also referred to as a cell).

In FIG. 1, a radio communication of the uplink r30 at least includes the following uplink physical channels. The uplink physical channels are used for transmitting information output from a higher layer.
Physical Uplink Control Channel (PUCCH)
Physical Uplink Shared Channel (PUSCH)
Physical Random Access Channel (PRACH)

The PUCCH is a physical channel that is used to transmit Uplink Control Information (UCI). The uplink control information includes a positive acknowledgement (ACK)/Negative acknowledgement (NACK) in response to downlink data (a Downlink transport block, a Medium Access Control Protocol Data Unit (MAC PDU), a Downlink-Shared Channel (DL-SCH), and a Physical Downlink Shared Channel (PDSCH). The ACK/NACK is also referred to as a Hybrid Automatic Repeat request ACKnowledgement (HARQ-ACK), a HARQ feedback, a HARQ response, or a signal indicating HARQ control information or a delivery confirmation.

The uplink control information includes a Scheduling Request (SR) used to request a PUSCH (Uplink-Shared Channel (UL-SCH)) resource for initial transmission. The scheduling request includes a positive scheduling request or a negative scheduling request. The positive scheduling request indicates that a UL-SCH resource for initial transmission is requested. The negative scheduling request indicates that the UL-SCH resource for the initial transmission is not requested.

The uplink control information includes downlink Channel State Information (CSI). The downlink channel state information includes a Rank Indicator (RI) indicating a preferable spatial multiplexing order (the number of layers), a Precoding Matrix Indicator (PMI) indicating a preferable precoder, a Channel Quality Indicator (CQI) specifying a preferable transmission rate, and the like. The PMI indicates a codebook determined by the terminal apparatus. The codebook is related to precoding of the physical downlink shared channel. The CQI can use an index (CQI index) indicative of a preferable modulation scheme (for example, QPSK, 16QAM, 64QAM, 256QAM, or the like), a preferable coding rate, and a preferable frequency utilization efficiency in a prescribed band. The terminal apparatus selects, from the CQI table, a CQI index considered to allow a transport block on the PDSCH to be received within a prescribed block error probability (for example, an error rate of 0.1). Here, the terminal apparatus may have multiple prescribed error probabilities (error rates) for transport blocks. For example, the error rate of the eMBB data may target 0.1 and the error rate of the URLLC may target 0.00001. The terminal apparatus may perform CSI feedback for each target error rate (transport block error rate) in a case of being configured by a higher layer (e.g., setup by RRC signaling from the base station), or may perform CSI feedback of a target error rate configured in a case that one of multiple target error rates is configured by a higher layer. Note that the CSI may be calculated by an error rate that is not an error rate (e.g. 0.1) for the eMBB, not based on whether or not the error rate is configured by RRC signaling, but based on whether or not the CQI table not for the eMBB (that is, transmissions where the BLER does not exceed 0.1) is selected.

The PUCCH is defined in PUCCH formats 0 to 4, and PUCCH formats 0 and 2 transmits on one to two OFDM symbols, and PUCCH formats 1, 3, and 4 transmits on four to 14 OFDM symbols. PUCCH formats 0 and 1 is used for two or fewer bits of notification, and can notify of only the HARQ-ACK, only the SR, or the HARQ-ACK and the SR simultaneously. PUCCH formats 1, 3, and 4 is used for more than two bits of notification, and can simultaneously notify of the HARQ-ACK, the SR, and the CSI. The number of OFDM symbols used for transmission of the PUCCH is configured by a higher layer (e.g., setup by RRC signaling), and the use of any PUCCH format depends on whether or not there is an SR transmission or a CSI transmission at the timing at which the PUCCH is transmitted (a slot, an OFDM symbol).

PUCCH-config, which is configuration information (configuration) for the PUCCH, includes the presence or absence of use of PUCCH formats 1 to 4, a PUCCH resource (starting physical resource block, PRB-Id), information on the association of PUCCH formats that can be used for each PUCCH resource, and a configuration of intra slot hopping, and also includes SchedulingRequestResourceConfig, which is SR configuration information. The SR configuration information includes a scheduling request ID, periodicity and offset of the scheduling request, and information of the PUCCH resource to be used. Note that the scheduling request ID is used for association of a SR prohibit timer and the maximum number of transmissions and a configuration of the SR configured by SchedulingRequestConfig in MAC-CellGroupConfig.

The PUSCH is a physical channel that is used to transmit uplink data (Uplink Transport Block, Uplink-Shared Channel (UL-SCH)). The PUSCH may be used to transmit the HARQ-ACK in response to the downlink data and/or the channel state information along with the uplink data. The PUSCH may be used to transmit only the channel state information. The PUSCH may be used to transmit only the HARQ-ACK and the channel state information.

The PUSCH is used to transmit Radio Resource Control (RRC) signaling. The RRC signaling is also referred to as an RRC message/RRC layer information/an RRC layer signal/an RRC layer parameter/RRC information/an RRC information element. The RRC signaling is information/signal processed in a radio resource control layer. The RRC signaling transmitted from the base station apparatus may be signaling common to multiple terminal apparatuses in a cell. The RRC signaling transmitted from the base station apparatus may be signaling dedicated to a certain terminal apparatus (also referred to as dedicated signaling). In other words, user equipment specific (UE-specific) information is transmitted through signaling dedicated to the certain terminal apparatus. The RRC message can include a UE Capability of the terminal apparatus. The UE Capability is information indicating a function supported by the terminal apparatus.

The PUSCH is used to transmit a Medium Access Control Element (MAC CE). The MAC CE is information/signal processed (transmitted) in a Medium Access Control layer. For example, a Power Headroom (PH) may be included in the MAC CE and may be reported via the physical uplink shared channel. In other words, a MAC CE field is used to indicate a level of the power headroom. The uplink data can include the RRC message and the MAC CE. The RRC signaling and/or the MAC CE is also referred to as a higher layer signal (higher layer signaling). The RRC signaling and/or the MAC CE are included in a transport block.

The PUSCH may be used for data transmission of dynamic scheduling (allocation of radio resources that are not periodic) for performing uplink data transmission with the specified radio resource, based on uplink transmission parameters (e.g., time domain resource allocation, frequency domain resource allocation, etc.) included in a DCI format. The PUSCH may be used for data transmission of Semi-Persistent scheduling (SPS) Type2 (Configured uplink grant type2) allowed for data transmission using periodic radio resources by receiving DCI format 0_0/0_1 in which a CRC is scrambled with a CS-RNTI, and by receiving activation control information in which the received DCI format 0_0/0_1 is configured for Validation in a prescribed field, after receiving the TransformPrecoder (precoder), nrofHARQ (HARQ process number), repK-RV (the pattern of the redundancy version during repeated transmission of the same data) by the RRC. Here, for the field used for the Validation, all bits of the HARQ process number, two bits of RV, and the like may be used. For the field used for the Validation of deactivation (release) control information of the type2 configured grant transmission, all bits of the HARQ process number, all bits of an MCS, all bits of resource block assignment, 2 bits of an RV or the like may be used. Furthermore, in addition to the information of the type2 configured grant transmission by the RRC, the PUSCH may be used for type1 configured grant transmission allowed for periodic data transmission by receiving rrcConfiguredUplinkGrant. The rrcConfiguredUplinkGrant information may include a time domain resource allocation, a time domain offset, a frequency domain resource allocation, a DMRS configuration, and a number of repeated transmissions of the same data (repK). In a case that the type1 configured grant transmission and the type2 configured grant transmission are configured in the same serving cell (in a component carrier), the type1 configured grant transmission may be prioritized. In a case that an uplink grant of the type1 configured grant transmission and an uplink grant of dynamic scheduling overlap in a time domain in the same serving cell, the uplink grant of the dynamic scheduling may override (use the dynamic scheduling only, and overturn the uplink grant of the type1 configured grant transmission). The overlapping of multiple uplink grants in the time domain may refer to overlapping in at least some of OFDM symbols, or may refer to overlapping in a portion of the time in the OFDM symbols because the OFDM symbol lengths differ in a case that a subcarrier spacing (SCS) is different. The configuration of the type1 configured grant transmission can also be configured for a Scell that has not been activated by the RRC, and in the Scell configured with the type1 configured grant transmission, the uplink grant of the type1 configured grant transmission may be enabled after the activation.

The PRACH is used to transmit a preamble used for random access. The PRACH is used for indicating an initial connection establishment procedure, a handover procedure, a connection re-establishment procedure, synchronization (timing adjustment) for uplink transmission, and a request for a PUSCH (UL-SCH) resource.

In the uplink radio communication, an Uplink Reference Signal (UL RS) is used as an uplink physical signal. The uplink reference signal includes a Demodulation Reference Signal (DMRS) and a Sounding Reference Signal (SRS). The DMRS is associated with transmission of the physical uplink shared channel/physical uplink control channel. For example, the base station apparatus 10 uses the demodulation reference signal to perform channel estimation/channel compensation in a case of demodulating the physical uplink-shared channel/the physical uplink control channel. An uplink DMRS is specified by the base station apparatus in RRC for the additional configuration (DMRS-add-pos) of the maximum number of OFDM symbols of a front-loaded DMRS and the DMRS symbol. In a case that the front-loaded DMRS is one OFDM symbol (single symbol DMRS), in the OFDM symbol including frequency domain allocation, a cyclic shift value in a frequency domain, and the DMRS, how different frequency domain allocations are used is specified by a DCI, and in a case that the front-loaded DMRS is two OFDM symbols (double symbol DMRS), the configuration of the time spread for the length of 2 is specified by the DCI in addition to the above.

The Sounding Reference Signal (SRS) is not associated with the transmission of the physical uplink shared channel/the physical uplink control channel. In other words, regardless of the presence or absence of uplink data transmission, the terminal apparatus transmits the SRS periodically or aperiodically. In the periodic SRS, the terminal apparatus transmits the SRS, based on a parameter notified by a higher layer signal (e.g., RRC) by the base station apparatus. On the other hand, in the aperiodic SRS, the terminal apparatus transmits the SRS, based on a physical downlink control channel (for example, DCI) indicating a parameter notified by a higher layer signal (e.g., RRC) by the base station apparatus and transmission timing of the SRS. The base station apparatus 10 uses the SRS to measure an uplink channel state (CSI Measurement). The base station apparatus 10 may perform timing alignment or closed loop transmission power control from the measurement results obtained by reception of the SRS.

In FIG. 1, at least the following downlink physical channels are used in radio communication of a downlink r31. The downlink physical channels are used for transmitting information output from the higher layer.
Physical Broadcast Channel (PBCH)
Physical Downlink Control Channel (PDCCH)
Physical Downlink Shared Channel (PDSCH)

The PBCH is used for broadcasting a Master Information Block (MIB, a Broadcast Channel (BCH)) that is used commonly by the terminal apparatuses. The MIB is one of pieces of system information. For example, the MIB includes a downlink transmission bandwidth configuration and a System Frame number (SFN). The MIB may include information indicating at least some of numbers of a slot, a subframe, and a radio frame in which a PBCH is transmitted.

The PDCCH is used to transmit Downlink Control Information (DCI). For the downlink control information, multiple formats based on applications (also referred to as DCI formats) are defined. The DCI format may be defined based on the type and the number of bits of the DCI constituting a single DCI format. The downlink control information includes control information for downlink data transmission and control information for uplink data transmission. The DCI format for downlink data transmission is also referred to as downlink assignment (or downlink grant, DL Grant). The DCI format for uplink data transmission is also referred to as uplink grant (or uplink assignment, UL Grant).

Examples of the DCI format for downlink data transmission include DCI format 1_0, DCI format 1_1, or the like. DCI format 1_0 is for downlink data transmission for fallback, and has fewer parameters (fields) that can be configured than DCI format 1_1 supporting MIMO and the like. DCI format 1_1 is capable of changing the presence or absence (validation/invalidation) of the parameters (fields) to be notified, and the number of bits is greater than the number of bits in DCI format 1_0 depending on the fields to be valid. On the other hand, DCI format 1_1 is capable of notifying of MIMO, multiple codeword transmission, ZP CSI-RS trigger, CBG transmission information, and the like, and the presence or absence of some fields and the number of bits are added in accordance with the configuration of the higher layer (e.g., RRC signaling, MAC CE). A single downlink assignment is used for scheduling a single PDSCH in a single serving cell. The downlink grant may be used for at least scheduling of the PDSCH within the same slot/subframe as the slot/subframe in which the downlink grant has been transmitted. The downlink grant may be used for the scheduling of the PDSCH K₀ slots/subframes after the slot/subframe in which the downlink grant is transmitted. The downlink grant may be used for the scheduling of the PDSCH of multiple slots/subframes. The downlink assignment by DCI format 1_0 includes the following fields. For example, a DCI format identifier, frequency domain resource assignment (resource block assignment for PDSCH, resource assignment), time domain resource assignment, VRB to PRB mapping, a Modulation and Coding Scheme (MCS) for PDSCH (information indicating a modulation number and coding rate), a NEW Data Indicator (NDI) for indicating an initial transmission or retransmission, information for indicating the HARQ process number in the downlink, a Redudancy version (RV) for indicating information of redundancy bits added to a codeword during error correction coding, a Downlink Assignment Index (DAI), a Transmission Power Control (TPC) command for the PUCCH, a resource indicator of the PUCCH, an indicator of HARQ feedback timing from the PDSCH, and the like are included. Note that the DCI format for each downlink data transmission includes information (fields) required for the application among the above-described information. Either or both of DCI format 1_0 and DCI format 1_1 may be used for activation and deactivation (release) of downlink SPS.

Examples of the DCI format for uplink data transmission includes DCI format 0_0 and DCI format 0_1. DCI format 0_0 is for uplink data transmission for fallback, and has fewer parameters (fields) that can be configured than DCI format 0_1 supporting MIMO and the like. DCI format 0_1 is capable of changing the presence or absence (validation/invalidation) of the parameters (fields) to be notified, and the number of bits is greater than the number of bits in DCI format 0_0 depending on the fields to be valid. On the other hand, DCI format 0_1 is capable of notifying of MIMO, multiple codeword transmission, a SRS resource indicator, precoding information, antenna port information, SRS request information, CSI request information, CBG transmission information, uplink PTRS association, sequence initialization of the DMRS, and the like, and the presence or absence of some fields and the number of bits are added in accordance with the configuration of the higher layer (e.g., RRC signaling). A single uplink grant is used for notifying the terminal apparatus of scheduling of a single PUSCH in a single serving cell. The uplink grant may be used for the scheduling of the PUSCH K2 slots/subframes after the slot/subframe in which the uplink grant is transmitted. The downlink grant may be used for the scheduling of the PUSCH of multiple slots/subframes. The uplink grant in DCI format 0_0 includes the following fields. For example, the DCI format identifier, the frequency domain resource assignment (information on the resource block assignment for transmitting the PUSCH, the time domain resource assignment, the frequency hopping flag, information on the MCS of the PUSCH, RV, NDI, information for indicating the HARQ process number in the uplink, the TPC command for the PUSCH, the Supplemental UL (UL/SUL) indicator, and the like are included. Either or both of DCI format 0_0 and DCI format 0_1 may be used for activation and deactivation (release) of uplink SPS.

The DCI format may be used for the notification of a slot format indicator (SFI) in DCI format 2_0 in which the CRC is scrambled with SFI-RNTI. The DCI format may be used in DCI format 2_1 in which the CRC is scrambled with INT-RNTI, for the notification of the PRB (one or more) and the OFDM symbol (one or more) in which the terminal apparatus may assume that there is no downlink data transmission intended for the terminal apparatus. The DCI format may be used for transmission of the TPC command for the PUSCH and the PUCCH in DCI format 2_2 in which the CRC is scrambled with TPC-PUSCH-RNTI or TPC-PUCCH-RNTI. The DCI format may be used for transmission of a group of TPC commands for SRS transmission by one or more terminal apparatuses in DCI format 2_3 in which the CRC is scrambled with TPC-SRS-RNTI. DCI format 2_3 may also be used for an SRS request. The DCI format may be used in DCI format 2_X (for example, DCI format 2_4, DCI format 2_1A) in which the CRC is scrambled with INT-RNTI or other RNTI (e.g., UL-INT-RNTI), for the notification of the PRB (one or more) and the OFDM symbol (one or more) in which the terminal apparatus does not perform data transmission, among those scheduled by the UL Grant/Configured UL Grant.

The MCS for the PDSCH/PUSCH can use an index (MCS index) for indicating a modulation order of the PDSCH/PUSCH and a target coding rate. The modulation order is associated with a modulation scheme. Modulation orders “2”, “4”, and “6” each indicate “QPSK,” “16QAM,” and “64QAM”. Furthermore, in a case that 256QAM and 1024QAM are configured by the higher layer (e.g., RRC signaling), modulation orders “8” and “10” can be notified, and “256QAM” and “1024QAM” are respectively indicated. The target coding rate is used to determine a TBS (transport block size), which is the number of bits to be transmitted, depending on the number of resource elements (number of resource blocks) of the PDSCH/PUSCH scheduled by the PDCCH. The communication system 1 (base station apparatus 10 and terminal apparatus 20) shares the method of calculating the transport block size by the MCS, the target coding rate, and the number of resource elements allocated for the PDSCH/PUSCH transmission (number of resource blocks).

The PDCCH is generated by adding a Cyclic Redundancy Check (CRC) to the downlink control information. In the PDCCH, CRC parity bits are scrambled with a prescribed identifier (also referred to as an exclusive OR operation, mask). The parity bits are scrambled with a Cell-Radio Network Temporary Identifier (C-RNTI), a Configured Scheduling (CS)-RNTI, a Temporary C (TC)-RNTI, a Paging (P)-RNTI, a System Information (SI)-RNTI, a Random Access (RA)-RNTI, a INT-RNTI, a Slot Format Indicator (SFI)-RNTI, a TPC-PUSCH-RNTI, a TPC-PUCCH-RNTI, or a TPC-SRS-RNTI. The C-RNTI is an identifier for identifying a terminal apparatus in a cell by dynamic scheduling, and the CS-RNTI is an identifier for identifying a terminal apparatus in a cell by SPS/grant free access. The Temporary C-RNTI is an identifier for identifying the terminal apparatus that has transmitted a random access preamble in a contention based random access procedure. The C-RNTI and the Temporary C-RNTI are used to control PDSCH transmission or PUSCH transmission in a single subframe. The CS-RNTI is used to periodically allocate a resource for the PDSCH or the PUSCH. The P-RNTI is used to transmit a paging message (Paging Channel (PCH)). The SI-RNTI is used to transmit an SIB, and the RA-RNTI is used to transmit a random access response (a message 2 in a random access procedure). The SFI-RNTI is used to notify of a slot format. The INT-RNTI is used to notify of downlink/uplink Pre-emption. The TPC-PUSCH-RNTI, the TPC-PUCCH-RNTI, and the TPC-SRS-RNTI are used to notify of transmission power control values of the PUSCH, the PUCCH, and the SRS, respectively. Note that the identifier may include a CS-RNTI for each configuration in order to configure multiple grant free access/SPS. The DCI to which the CRC scrambled with the CS-RNTI is added can be used for grant free access activation, deactivation (release), parameter change, retransmission control (ACK/NACK transmission), or the like, and the parameter may include a resource configuration (a configuration parameter for the DMRS, a resource in the frequency domain and the time domain of grant free access, the MCS used for grant free access, the number of repetitions, the presence or absence of frequency hopping, etc.).

The PDSCH is used to transmit the downlink data (the downlink transport block, DL-SCH). The PDSCH is used to transmit a system information message (also referred to as a System Information Block (SIB)). Some or all of the SIBs can be included in the RRC message.

The PDSCH is used to transmit the RRC signaling. The RRC signaling transmitted from the base station apparatus may be common to the multiple terminal apparatuses in the cell (unique to the cell). That is, the information common to the user equipments in the cell is transmitted by using the RRC signaling unique to the cell. The RRC signaling transmitted from the base station apparatus may be a message dedicated to a certain terminal apparatus (also referred to as dedicated signaling). In other words, user equipment specific (UE-Specific) information is transmitted by using messages dedicated to the certain terminal apparatus.

The PDSCH is used to transmit the MAC CE. The RRC signaling and/or the MAC CE is also referred to as a higher layer signal (higher layer signaling). The PMCH is used to transmit multicast data (Multicast Channel (MCH)).

In the downlink radio communication in FIG. 1, a Synchronization signal (SS) and a Downlink Reference Signal (DL RS) are used as downlink physical signals.

The synchronization signal is used for the terminal apparatus to take synchronization in the frequency domain and the time domain in the downlink. The downlink reference signal is used for the terminal apparatus to perform the channel estimation/channel compensation on the downlink physical channel. For example, the downlink reference signal is used to demodulate the PBCH, the PDSCH, and the PDCCH. The downlink reference signal can be used for the terminal apparatus to measure the downlink channel state (CSI measurement). The downlink reference signal can include a Cell-specific Reference Signal (CRS), a Channel state information Reference Signal (CSI-RS), a Discovery Reference Signal (DRS), or a Demodulation Reference Signal (DMRS).

The downlink physical channel and the downlink physical signal are also collectively referred to as a downlink signal. The uplink physical channel and the uplink physical signal are also collectively referred to as an uplink signal. The downlink physical channel and the uplink physical channel are also collectively referred to as a physical channel. The downlink physical signal and the uplink physical signal are also collectively referred to as a physical signal.

The BCH, the UL-SCH, and the DL-SCH are transport channels. Channels used in the Medium Access Control (MAC) layer are referred to as transport channels. A unit of the transport channel used in the MAC layer is also referred to as a Transport Block (TB) or a MAC Protocol Data Unit (PDU). The transport block is a unit of data that the MAC layer delivers to the physical layer. In the physical layer, the transport block is mapped to a codeword, and coding processing and the like are performed for each codeword.

The higher layer processing performs processing on a layer, such as a Medium Access Control (MAC) layer, a Packet Data Convergence Protocol (PDCP) layer, a Radio Link Control (RLC) layer, and a Radio Resource Control (RRC) layer, that is higher than the physical layer.

The higher layer processing performs processing on a layer, such as a Medium Access Control (MAC) layer, a Packet Data Convergence Protocol (PDCP) layer, a Radio Link Control (RLC) layer, and a Radio Resource Control (RRC) layer, that is higher than the physical layer.

A higher layer processing unit configures various RNTIs for each terminal apparatus. The RNTI is used for encryption (scrambling) of the PDCCH, the PDSCH, and the like. The higher layer processing generates, or acquires them from higher nodes, the downlink data (transport block, DL-SCH) allocated to the PDSCH, the system information specific to the terminal apparatus (System Information Block (SIB), the RRC message, the MAC CE, and the like, and transmit them. The higher layer processing manages various kinds of configuration information of the terminal apparatus 20. Note that a part of the function of radio resource control may be performed in the MAC layer or the physical layer.

The higher layer processing receives information on the terminal apparatus, such as the function supported by the terminal apparatus (UE capability), from the terminal apparatus 20. The terminal apparatus 20 transmits its own function to the base station apparatus 10 by a higher layer signaling (RRC signaling). The information on the terminal apparatus includes information for indicating whether the terminal apparatus supports a prescribed function or information for indicating that the terminal apparatus has completed introduction and testing of the prescribed function. The information for indicating whether the prescribed function is supported includes information for indicating whether the introduction and testing of the prescribed function have been completed.

In a case that the terminal apparatus supports the prescribed function, the terminal apparatus transmits information (parameters) for indicating whether the prescribed function is supported. In a case that a terminal apparatus does not support the prescribed function, the terminal apparatus may not transmit information (parameters) for indicating whether the prescribed function is supported. In other words, whether the prescribed function is supported is notified by whether information (parameters) for indicating whether the prescribed function is supported is transmitted. The information (parameters) for indicating whether the prescribed function is supported may be notified by using one bit of 1 or 0.

In FIG. 1, the base station apparatus 10 and the terminal apparatus 20 supports Multiple Access (MA) by using the grant free access (also referred to as grant less access, Contention-based access, Autonomous access, Resource allocation for uplink transmission without grant, type1 configured grant transmission, and the like, hereinafter referred to as grant free access) in the uplink. The grant free access is a scheme for the terminal apparatus to transmit uplink data (such as a physical uplink channel) without performing a procedure for specifying the physical resources or transmission timing for a transmission of SR by the terminal apparatus and a transmission of data by UL Grant (also referred to as UL Grant by L1 signaling) using the DCI by the base station apparatus. Thus, by RRC signaling (SPS-config), in addition to allocation periodicity of the resources that can be used, target received power, a value (α) of the fractional TPC, the number of HARQ processes, and a RV pattern during repeated transmission of the same transport, the terminal apparatus can receive physical resources (resource assignment in the frequency domain, resource assignment in the time domain) that can be used in the grant free access, or transmission parameters (a cyclic shift of DMRS, an OCC, an antenna port number, the position and number of OFDM symbols in which the DMRS is allocated, the number of repeated transmissions of the same transport, and the like may be included) in advance, as the Configured Uplink Grant (rrcConfiguredUplinkGrant, configured uplink grant) of the RRC signaling, and perform data transmission by using the configured physical resources only in a case that the transmission data is in a buffer. In other words, in a case that the higher layer does not carry transport blocks to transmit in grant free access, data transmission of grant free access is not performed. In a case that the terminal apparatus receives the SPS-config, but does not receive Configured Uplink Grant of the RRC signaling, similar data transmission can be performed in the SPS (type2 configured grant transmission) by the activation of the SPS by the UL Grant.

There are two types of grant free access. The first type1 configured grant transmission (UL-TWG-type1) is a method in which the base station apparatus transmits a transmission parameter related to grant free access to the terminal apparatus in a higher layer signal (e.g., RRC), and further transmits a start of grant for grant free access data transmission (activation, RRC setup), an end of grant (deactivation (release), RRC release), and a transmission parameter change in a higher layer signal. Here, examples of the transmission parameter related to grant free access may include the information related to the physical resource (resource assignment of the time domain and the frequency domain) that can be used for data transmission of grant free access, the periodicity of the physical resource, the MCS, the presence or absence of repeated transmissions, the number of repetitions, the configuration of the RV during repeated transmission, the presence or absence of frequency hopping, the hopping pattern, the configuration of the DMRS (such as the number of OFDM symbols in the front-loaded DMRS, the configuration of the cyclic shift and the time spread, and the like), the number of processes of the HARQ, the information of the transformer precoder, and the configuration related to the TPC. The transmission parameter and the start of grant for data transmission related to grant free access may be configured simultaneously, or, after the transmission parameter related to grant free access is configured, the start of grant for data transmission of grant free access may be configured at different timings (SCell activation, etc. in the case of SCell). In the second type2 configured grant transmission (UL-TWG-type2), the base station apparatus transmits a transmission parameter related to grant free access to the terminal apparatus in a higher layer signal (e.g., RRC), and transmits a start of grant for grant free access data transmission (activation), an end of grant (deactivation (release)), and a transmission parameter change in the DCI (L1 signaling). Here, the RRC may include information related to the periodicity of the physical resource, the number of repetitions, the configuration of the RV during the repeated transmission, the number of processes of the HARQ, the information of the transformer precoder, and the configuration related to the TPC, and the start of grant (activation) by the DCI may include a physical resource (allocation of resource blocks) that can be used for grant free access. The transmission parameter and the start of grant for data transmission related to grant free access may be configured simultaneously, or, after the transmission parameter related to grant free access is configured, the start of grant for data transmission of grant free access may be configured at different timings. One aspect of the present invention may be applied to any types of the grant free access described above.

On the other hand, a technology called Semi-Persistent Scheduling (SPS) is introduced in LTE, and periodic resource allocation is possible mainly in Voice over Internet Protocol (VoIP) applications. In the SPS, the DCI is used to perform a start of grant (activation) by the UL Grant including a transmission parameter such as a physical resource specification (allocation of resource blocks) or MCS. Therefore, a type (UL-TWG-type1) for starting a grant (activation) by a higher layer signaling (e.g., RRC) of grant free access differs from the SPS in the starting procedure. The UL-TWG-type2 is same in that the start of grant (activation) is performed by the DCI (L1 signaling), but may be different in that it is used in the SCell, the BWP, or the SUL, or in that the number of repetitions or the configuration of the RV during repeated transmission is notified by the RRC signaling. The base station apparatus may scramble with different types of RNTIs in the DCI (L1 signaling) used in the grant free access (UL-TWG-type1 and UL-TWG-type2) and in the DCI used in the dynamic scheduling, or may scramble with the same RNTI in the DCI used in the retransmission control of the UL-TWG-type1 and the DCI used in the activation, the deactivation (release), and the retransmission control of the UL-TWG-type2.

The base station apparatus 10 and the terminal apparatuses 20 may support non-orthogonal multiple access in addition to orthogonal multiple access. Note that the base station apparatus 10 and the terminal apparatuses 20 can support both the grant free access and scheduled access (dynamic scheduling). Here, an uplink scheduled access refers to the terminal apparatus 20 transmitting data according to the following procedure. The terminal apparatus 20 requests a radio resource for transmitting uplink data to the base station apparatus 10 by using Random Access Procedure or SR. The base station apparatus provides UL Grant by the DCI to each terminal apparatus, based on the RACH or the SR. In a case that the terminal apparatus receives UL Grant for control information from the base station apparatus, the terminal apparatus transmits uplink data using a prescribed radio resource, based on an uplink transmission parameter included in the UL Grant.

The downlink control information for physical channel transmission in the uplink may include a shared field shared between the scheduled access and the grant free access. In this case, in a case that the base station apparatus 10 indicates transmission of the uplink physical channel using the grant free access, the base station apparatus 10 and the terminal apparatus 20 interpret a bit sequence stored in the shared field in accordance with a configuration for the grant free access (e.g., a look-up table defined for the grant free access). Similarly, in a case that the base station apparatus 10 indicates transmission of the uplink physical channel using the scheduled access, the base station apparatus 10 and the terminal apparatus 20 interpret the shared field in accordance with a configuration for the scheduled access. Transmission of the uplink physical channel in the grant free access is referred to as Asynchronous data transmission. Note that the transmission of the uplink physical channel in the scheduled is referred to as Synchronous data transmission.

In the grant free access, the terminal apparatus 20 may randomly select a radio resource for transmission of uplink data. For example, the terminal apparatus 20 has been notified, by the base station apparatus 10, of multiple candidates for available radio resources as a resource pool, and randomly selects a radio resource from the resource pool. In the grant free access, the radio resource in which the terminal apparatus 20 transmits the uplink data may be configured in advance by the base station apparatus 10. In this case, the terminal apparatus 20 transmits the uplink data by using the radio resource configured in advance without receiving the UL Grant of DCI (including the specification of the physical resources). The radio resource includes multiple uplink multiple access resources (resources to which the uplink data can be mapped). The terminal apparatus 20 transmits the uplink data by using one or more uplink multiple access resources selected from the multiple uplink multiple access resources. Note that the radio resource in which the terminal apparatus 20 transmits the uplink data may be predetermined in the communication system including the base station apparatus 10 and the terminal apparatus 20. The radio resource for transmission of the uplink data may be notified to the terminal apparatus 20 by the base station apparatus 10 by using a physical broadcast channel (e.g., Physical Broadcast Channel (PBCH)/Radio Resource Control (RRC)/system information (e.g. System Information Block (SIB)/physical downlink control channel (downlink control information, e.g., Physical Downlink Control Channel (PDCCH), Enhanced PDCCH (EPDCCH), or MTC PDCCH (MPDCCH), or Narrowband PDCCH (NPDCCH)).

In the grant free access, the uplink multiple access resource includes a multiple access physical resource and a Multi-Access Signature Resource. The multiple access physical resource is a resource including time and frequency. The multiple access physical resource and the multi-access signature resource may be used to identify the uplink physical channel transmitted by each terminal apparatus. The resource blocks are units to which the base station apparatus 10 and the terminal apparatus 20 are capable of mapping the physical channel (e.g., the physical data shared channel or the physical control channel). Each of the resource blocks includes one or more subcarriers (e.g., 12 subcarriers or 16 subcarriers) in a frequency domain.

The multi-access signature resource includes at least one multi-access signature of multiple multi-access signature groups (also referred to as multi-access signature pools). The multi-access signature is information indicating a characteristic (mark or indicator) that distinguishes (identifies) the uplink physical channel transmitted by each terminal apparatus. Examples of the multi-access signature include a spatial multiplexing pattern, a spreading code pattern (a Walsh code, an Orthogonal Cover Code (OCC), a cyclic shift for data spreading, the sparse code, or the like), an interleaving pattern, a demodulation reference signal pattern (a reference signal sequence, the cyclic shift, the OCC, or IFDM)/an identification signal pattern, and transmit power, at least one of which is included in the multi-access signature. In the grant free access, the terminal apparatus 20 transmits the uplink data by using one or more multi-access signatures selected from the multi-access signature pool. The terminal apparatus 20 can notify the base station apparatus 10 of available multi-access signatures. The base station apparatus 10 can notify the terminal apparatus of a multi-access signature used by the terminal apparatus 20 to transmit the uplink data. The base station apparatus 10 can notify the terminal apparatus 20 of an available multi-access signature group by the terminal apparatus 20 to transmit the uplink data. The available multi-access signature group may be notified by using the broadcast channel/RRC/system information/downlink control channel. In this case, the terminal apparatus 20 can transmit the uplink data by using a multi-access signature selected from the notified multi-access signature group.

The terminal apparatus 20 transmits the uplink data by using a multiple access resource. For example, the terminal apparatus 20 can map the uplink data to a multiple access resource including a multi-carrier signature resource including one multiple access physical resource, a spreading code pattern, and the like. The terminal apparatus 20 can allocate the uplink data to a multiple access resource including a multi-carrier signature resource including one multiple access physical resource and an interleaving pattern. The terminal apparatus 20 can also map the uplink data to a multiple access resource including a multi-access signature resource including one multiple access physical resource and a demodulation reference signal pattern/identification signal pattern. The terminal apparatus 20 can also map the uplink data to a multiple access resource including one multiple access physical resource and a multi-access signature resource including a transmit power pattern (e.g., the transmit power for each of the uplink data may be configured to cause a difference in receive power at the base station apparatus 10). In such grant free access, the communication system of the present embodiment may allow the uplink data transmitted by the multiple terminal apparatuses 20 to overlap (superpose, spatial multiplex, non-orthogonally multiplex, collide) with one another in the uplink multiple access physical resource.

The base station apparatus 10 detects, in the grant free access, a signal of the uplink data transmitted by each terminal apparatus. To detect the uplink data signal, the base station apparatus 10 may include Symbol Level Interference Cancellation (SLIC) in which interference is canceled based on a demodulation result for an interference signal, Codeword Level Interference Cancellation (CWIC, also referred to as Sequential Interference Canceler (SIC) or Parallel Interference Canceler (PIC)) in which interference is canceled based on the decoding result for the interference signal, turbo equalization, maximum likelihood detection (MLD, Reduced complexity maximum likelihood detection (R-MLD)) in which transmit signal candidates are searched for the most probable signal, Enhanced Minimum Mean Square Error-Interference Rejection Combining (EMMSE-IRC) in which interference signals are suppressed by linear computation, signal detection based on message passing (Belief propagation (BP), Matched Filter (MF)-BP in which a matched filter is combined with BP, or the like.

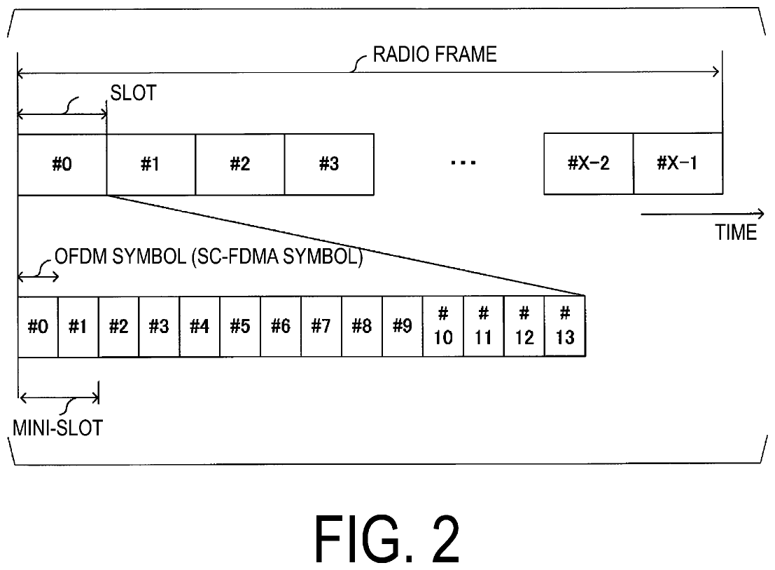

FIG. 2 is a diagram illustrating an example of a radio frame structure for a communication system according to the present embodiment. The radio frame structure indicates a configuration of multiple access physical resources in a time domain. One radio frame includes multiple slots (or subframes). FIG. 2 is an example in which one radio frame includes 10 slots. The terminal apparatus 20 has a subcarrier spacing used as a reference (reference numerology). The subframe includes multiple OFDM symbols generated at the subcarrier spacings used as the reference. FIG. 2 is an example in which the subcarrier spacing is 15 kHz, one frame includes 10 slots, one subframe includes one slot, and one slot includes 14 OFDM symbols. In the case that the subcarrier spacing is 15 kHz*2μ (μ is an integer of 0 or greater), one frame includes 2 μ*10 slots and one subframe includes 2μ slots.

FIG. 2 illustrates a case that the subcarrier spacing used as the reference is the same as a subcarrier spacing used for the uplink data transmission. The communication system according to the present embodiment may use slots as minimum units to which the terminal apparatus 20 maps the physical channel (e.g., the physical data shared channel or the physical control channel). In this case, in the multiple access physical resource, one slot is defined as a resource block unit in the time domain. Furthermore, in the communication system according to the present embodiment, the minimum unit for mapping a physical channel by the terminal apparatus 20 may be one or multiple OFDM symbols (e.g., 2 to 13 OFDM symbols). The base station apparatus 10 uses one or multiple OFDM symbols as resource block units in the time domain. The base station apparatus 10 may signal the minimum unit for mapping a physical channel to the terminal apparatus 20.

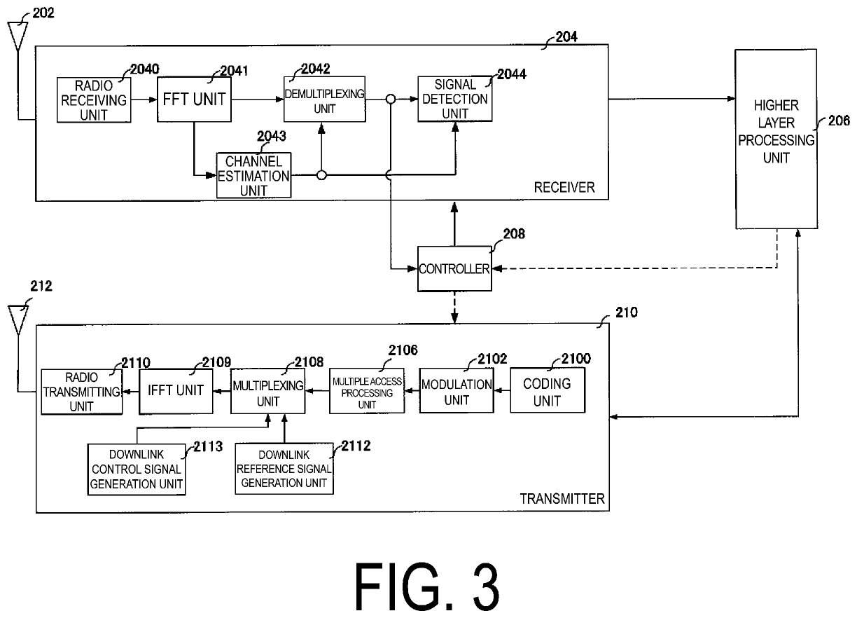

FIG. 3 is a schematic block diagram illustrating a configuration of the base station apparatus 10 according to the present embodiment. The base station apparatus 10 includes a receive antenna 202, a receiver (receiving step) 204, a higher layer processing unit (higher layer processing step) 206, a controller (control step) 208, a transmitter (transmitting step) 210, and a transmit antenna 212. The receiver 204 includes a radio receiving unit (radio receiving step) 2040, an FFT unit 2041 (FFT step), a demultiplexing unit (demultiplexing step) 2042, a channel estimation unit (channel estimating step) 2043, and a signal detection unit (signal detecting step) 2044. The transmitter 210 includes a coding unit (coding step) 2100, a modulation unit (modulation step) 2102, a multiple access processing unit (multiple access processing step) 2106, a multiplexing unit (multiplexing step) 2108, a radio transmitting unit (radio transmitting step) 2110, a IFFT unit (IFFT step) 2109, a downlink reference signal generation unit (downlink reference signal generating step) 2112, and a downlink control signal generation unit (downlink control signal generating step) 2113.

The receiver 204 demultiplexes, demodulates, and decodes an uplink signal (uplink physical channel, uplink physical signal) received from the terminal apparatus 10 via the receive antenna 202. The receiver 204 outputs a control channel (control information) separated from the received signal to the controller 208. The receiver 204 outputs a decoding result to the higher layer processing unit 206. The receiver 204 acquires ACK/NACK and CSI for the SR and downlink data transmission included in the received signal.

The radio receiving unit 2040 converts, by down-conversion, an uplink signal received through the receive antenna 202 into a baseband signal, removes unnecessary frequency components from the baseband signal, controls an amplification level in such a manner as to suitably maintain a signal level, orthogonally demodulates the signal, based on an in-phase component and an orthogonal component of the received signal, and converts the resulting orthogonally-demodulated analog signal into a digital signal. The radio receiving unit 2040 removes a portion of the digital signal resulting from the conversion, the portion corresponding to a Cyclic Prefix (CP). The FFT unit 2041 performs a fast Fourier transform on the downlink signal from which CP has been removed (demodulation processing for OFDM modulation), and extracts the signal in the frequency domain.

The channel estimation unit 2043 uses the demodulation reference signal to perform channel estimation for signal detection for the uplink physical channel. The channel estimation unit 2043 receives as inputs, from the controller 208, the resources to which a demodulation reference signal are mapped and the demodulation reference signal sequence allocated to each terminal apparatus. The channel estimation unit 2043 uses the demodulation reference signal sequence to measure a channel state between the base station apparatus 10 and the terminal apparatus 20. The channel estimation unit 2043 can identify the terminal apparatus by using the result of channel estimation (impulse response and frequency response with the channel state) (the channel estimation unit 2043 is thus also referred to as an identification unit), in a case of grant free access. The channel estimation unit 2043 determines that an uplink physical channel has been transmitted by the terminal apparatus 20 associated with the demodulation reference signal from which the channel state has been successfully extracted. In the resource on which the uplink physical channel is determined by the channel estimation unit 2043 to have been transmitted, the demultiplexing unit 2042 extracts the signal in the frequency domain input from the FFT unit 2041 (the signal includes signals from multiple terminal apparatuses 20).

The demultiplexing unit 2042 separates and extracts the uplink physical channel (physical uplink control channel, physical uplink shared channel) and the like included in the extracted uplink signal in the frequency domain. The demultiplexing unit outputs the physical uplink channel to the signal detection unit 2044/controller 208.

The signal detection unit 2044 uses the channel estimation result estimated by the channel estimation unit 2043 and the signal in the frequency domain input from the demultiplexing unit 2042 to detect a signal of uplink data (uplink physical channel) from each terminal apparatus. The signal detection unit 2044 performs detection processing for a signal from the terminal apparatus 20 associated with the demodulation reference signal (demodulation reference signal from which the channel state has been successfully extracted) allocated to the terminal apparatus 20 determined to have transmitted the uplink data.

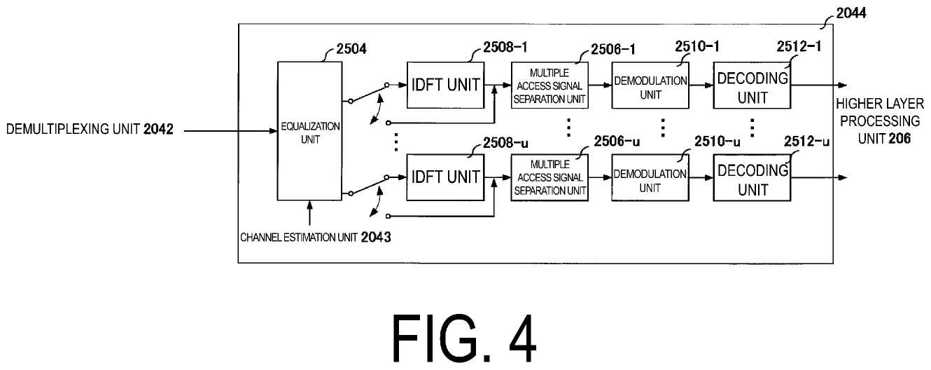

FIG. 4 is a diagram illustrating an example of the signal detection unit according to the present embodiment. The signal detection unit 2044 includes an equalization unit 2504, multiple access signal separation units 2506-1 to 2506-u, IDFT units 2508-1 to 2508-u, demodulation units 2510-1 to 2510-u, and decoding units 2512-1 to 2512-u. u is the number of terminal apparatuses determined by the channel estimation unit 2043 to have transmitted uplink data (for which the channel state has been successfully extracted) in the same multiple access physical resource or overlapping multiple access physical resources (at the same time and at the same frequency) in the case of grant free access. In the case of scheduled access, u is a number of terminal apparatuses that have allowed uplink data transmission in the same multiple access physical resource or overlapping multiple access physical resources in the DCI (at the same time, for example, in OFDM symbols, slots). Each of the portions constituting the signal detection unit 2044 is controlled by using the configuration related to the grant free access for each terminal apparatus and input from the controller 208.

The equalization unit 2504 generates an equalization weight based on the MMSE standard, from the frequency response input from the channel estimation unit 2043. Here, MRC and ZF may be used for the equalization processing. The equalization unit 2504 multiplies the equalization weight by the signal (including signals of each terminal apparatus) in the frequency domain input from the demultiplexing unit 2042, and extracts the signal in the frequency domain from each terminal apparatus. The equalization unit 2504 outputs the equalized signal in the frequency domain from each terminal apparatus to the IDFT units 2508-1 to 2508-u. Here, in a case that data is to be detected that is transmitted by the terminal apparatus 20 and that uses the DFTS-OFDM signal waveform, the signal in the frequency domain is output to the IDFT units 2508-1 to 2508-u. In a case that data is to be received that is transmitted by the terminal apparatus 20 and that uses the OFDM signal waveform, the signal in the frequency domain is output to the multiple access signal separation units 2506-1 to 2506-u.

The IDFT units 2508-1 to 2508-u converts the equalized signal in the frequency domain from each terminal apparatus into a signal in the time domain. Note that the IDFT units 2508-1 to 2508-u correspond to processing performed by the DFT unit of the terminal apparatus 20. The multiple access signal separation units 2506-1 to 2506-u separates the signal multiplexed by the multi-access signature resource from the signal in the time domain from each terminal apparatus after conversion with the IDFT (multiple access signal separation processing). For example, in a case that code spreading is used as a multi-access signature resource, each of the multiple access signal separation units 2506-1 to 2506-u performs inverse spreading processing by using the spreading code sequence assigned to each terminal apparatus. Note that, in a case that interleaving is applied as a multi-access signature resource, de-interleaving is performed on the signal in the time domain from each terminal apparatus after conversion with the IDFT (deinterleaving unit).

The demodulation units 2510-1 to 2510-u receive as an input, from the controller 208, pre-notified or predetermined information about the modulation scheme of each terminal apparatus (BPSK, QPSK, 16QAM, 64QAM, 256QAM, or the like). Based on the information about the modulation scheme, the demodulation units 2510-1 to 2510-u perform demodulation processing on the separated multiple access signal, and outputs a Log Likelihood Ratio (LLR) of the bit sequence.

The decoding units 2512-1 to 2512-u receives as an input, from the controller 208, pre-notified or predetermined information about the coding rate. The decoding units 2512-1 to 2512-u perform decoding processing on the LLR sequences output from the demodulation units 2510-1 to 2510-u, and outputs the decoded uplink data/uplink control information to the higher layer processing unit 206. In order to perform cancellation processing such as a Successive Interference Canceller (SIC) or turbo equalization, the decoding units 2512-1 to 2512-u may generate a replica from external LLRs or post LLRs output from the decoding units. A difference between the external LLR and the post LLR is whether to subtract, from the decoded LLR, the pre LLR input to each of the decoding units 2512-1 to 2512-u. In a case that the number of repetitions of SIC or turbo equalization is larger than or equal to a prescribed value, the decoding units 2512-1 to 2512-u perform hard decision on the LLR resulting from the decoding processing, and may output the bit sequence of the uplink data for each terminal apparatus to the higher layer processing unit 206. Note that, the signal detection using the turbo equalization processing is not limited thereto, and can be replaced with signal detection based on replica generation and using no interference cancellation, maximum likelihood detection, EMMSE-IRC, or the like.

The controller 208 controls the receiver 204 and the transmitter 210 by using the configuration information (notified from the base station apparatus to the terminal apparatus in DCI, RRC, SIB, and the like) related to the uplink reception/configuration information related to the downlink transmission included in the uplink physical channel (physical uplink control channel, physical uplink shared channel, or the like). The controller 208 acquires the configuration information related to the uplink reception/the configuration information related to the downlink transmission from the higher layer processing unit 206. In a case that the transmitter 210 transmits the physical downlink control channel, the controller 208 generates Downlink Control information (DCI) and outputs the resultant information to the transmitter 210. Note that some of the functions of the controller 108 can be included in the higher layer processing unit 102. Note that the controller 208 may control the transmitter 210 in accordance with the parameter of the CP length added to the data signal.

The higher layer processing unit 206 performs processing of layers higher than the physical layer, such as the Medium Access Control (MAC) layer, the Packet Data Convergence Protocol (PDCP) layer, the Radio Link Control (RLC) layer, and the Radio Resource Control (RRC) layer. The higher layer processing unit 206 generates information needed to control the transmitter 210 and the receiver 204, and outputs the resultant information to the controller 208. The higher layer processing unit 206 outputs downlink data (e.g., the DL-SCH), broadcast information (e.g., the BCH), a Hybrid Automatic Repeat request indicator (HARQ indicator), and the like to the transmitter 210. The higher layer processing unit 206 is input, from the receiver 204, information related to a function of the terminal apparatus (UE capability) supported from the terminal apparatus. For example, the higher layer processing unit 206 receives, in the RRC layer signaling, information related to the function of the terminal apparatus.

The information related to the function of the terminal apparatus includes information indicating whether the terminal apparatus supports a prescribed function, or information indicating that the terminal apparatus has completed introduction and testing of a prescribed function. The information for indicating whether the prescribed function is supported includes information for indicating whether the introduction and testing of the prescribed function have been completed. In a case that the terminal apparatus supports the prescribed function, the terminal apparatus transmits information (parameters) for indicating whether the prescribed function is supported. In a case that the terminal apparatus does not support the prescribed function, the terminal apparatus may be configured not to transmit information (parameters) for indicating whether the prescribed function is supported. In other words, whether the prescribed function is supported is notified by whether information (parameters) for indicating whether the prescribed function is supported is transmitted. The information (parameters) for indicating whether the prescribed function is supported may be notified by using one bit of 1 or 0.

The information related to the function of the terminal apparatus includes information indicating that the grant free access is supported (information whether or not the terminal apparatus supports UL-TWG-type1 or UL-TWG-type2). In a case that multiple functions corresponding to the grant free access are provided, the higher layer processing unit 206 can receive information indicating whether the grant free access is supported on a function-by-orney Docket No.: US82809 function basis. The information indicating that the grant free access is supported includes information indicating the multiple access physical resource and multi-access signature resource supported by the terminal apparatus. The information indicating that the grant free access is supported may include a configuration of a lookup table for the configuration of the multiple access physical resource and the multi-access signature resource. The information indicating that the grant free access is supported may include some or all of an antenna port, a capability corresponding to multiple tables indicating a scrambling identity and the number of layers, a capability corresponding to a prescribed number of antenna ports, and a capability corresponding to a prescribed transmission mode. The transmission mode is determined by the number of antenna ports, transmission diversity, the number of layers, and whether support of the grant free access and the like are provided.

The information related to the function of the terminal apparatus may include information indicating that the function related to the URLLC is supported. For example, an example of a DCI format of uplink dynamic scheduling or SPS/grant free access, or downlink dynamic scheduling or SPS includes a compact DCI format with a small total number of bits of the fields in the DCI format, and the information related to the function of the terminal apparatus may include information indicating that the reception processing (blind decoding) of the compact DCI format is supported. The DCI format is allocated and transmitted in the search space of the PDCCH, but the number of resources that can be used for each aggregation level is determined. Therefore, in a case that the total number of bits of the field in the DCI format is higher, the coding rate of the transmission is higher, and in a case that the total number of bits in the field in the DCI format is smaller, the coding rate of the transmission is lower. Therefore, in a case that high reliability such as URLLC is required, it is preferable to use the compact DCI format. Note that in LTE or NR, the DCI format is placed in a resource element (search space) predetermined. Therefore, in a case that the number of resource elements (aggregation level) is constant, a DCI format with a large payload size is a transmission of a higher coding rate compared to a DCI format with a small payload size, and it is difficult to satisfy the high reliability.

The information related to the function of the terminal apparatus may include information indicating that the function related to the URLLC is supported. For example, by repeatedly transmitting the information of the DCI format of dynamic scheduling of the uplink or the downlink, information indicating that the high reliability detection of the PDCCH (detection by blind decoding) is supported may be included. In a case that the information of the DCI format is transmitted repeatedly on the PDCCH, the base station apparatus may repeatedly transmit the information of the same DCI format in a prescribed rule in association with candidates for blind decoding in the search space repeatedly transmitted, the aggregation level, the search space, the CORESET, the BWP, the serving cell, and the slot.

The information related to the function of the terminal apparatus may include information indicating that the function related to the carrier aggregation is supported. The information related to the function of the terminal apparatus may include information indicating that the function related to simultaneous transmission of multiple component carriers (serving cells) (including a case of overlapping in the time domain, overlapping at least some OFDM symbols) is supported.

The higher layer processing unit 206 manages various types of configuration information about the terminal apparatus. Some of the various types of configuration information are input to the controller 208. The various types of configuration information are transmitted from the base station apparatus 10 via the transmitter 210 by using the downlink physical channel. The various types of configuration information include configuration information related to the grant free access input from the transmitter 210. The configuration information related to the grant free access includes configuration information about the multiple access resources (multiple access physical resources and multi-access signature resources). For example, the configuration information related to the grant free access may include a configuration related to the multi-access signature resource (configuration related to processing performed based on a mark for identifying the uplink physical channel transmitted by the terminal apparatus 20), such as an uplink resource block configuration (starting position of the OFDM symbols to be used and the number of the OFDM symbols/the number of resource blocks), a configuration of the demodulation reference signal/identification signal (reference signal sequence, cyclic shift, OFDM symbols to be mapped, and the like), a spreading code configuration (Walsh code, Orthogonal Cover Code (OCC), sparse code, spreading rates of these spreading codes, and the like), an interleaving configuration, a transmit power configuration, a transmit and/or receive antenna configuration, and a transmit and/or receive beamforming configuration. These multi-access signature resources may be directly or indirectly associated (linked) with one another. The association of the multi-access signature resources is indicated by a multi-access signature process index. The configuration information related to the grant free access may include the configuration of the look-up table for the configuration of the multiple access physical resource and multi-access signature resource. The configuration information related to the grant free access may include setup of the grant free access, information indicating release, ACK/NACK reception timing information for uplink data signals, retransmission timing information for uplink data signals, and the like.

Based on the configuration information related to the grant free access notified as the control information, the higher layer processing unit 206 manages multiple access resources (multiple access physical resources, multi-access signature resources) of uplink data (transport blocks) in a grant free. Based on the configuration information related to the grant free access, the higher layer processing unit 206 outputs, to the controller 208, information used to control the receiver 204.

The higher layer processing unit 206 outputs, to the transmitter 210, generated downlink data (e.g., DL-SCH). The downlink data may include a field storing the UE ID (RNTI). The higher layer processing unit 206 adds the CRC to the downlink data. The CRC parity bits are generated by using the downlink data. The CRC parity bits are scrambled with the UE ID (RNTI) allocated to the terminal apparatus to be addressed (the scrambling is also referred to as an exclusive-OR operation, masking, or ciphering). However, as described above, multiple types of RNTI exist, and a different RNTI is used depending on the data to be transmitted, and the like.

The higher layer processing unit 206 generates or acquires from a higher node, system information (MIB, SIB) to be broadcasted. The higher layer processing unit 206 outputs, to the transmitter 210, the system information to be broadcasted. The system information to be broadcasted can include information indicating that the base station apparatus 10 supports the grant free access. The higher layer processing unit 206 can include, in the system information, a portion or all of the configuration information related to the grant free access (such as the configuration information related to the multiple access resources such as the multiple access physical resource, the multi-access signature resource). The uplink system control information is mapped to the physical broadcast channel/physical downlink shared channel in the transmitter 210.

The higher layer processing unit 206 generates or acquires from a higher node, downlink data (transport blocks) to be mapped to the physical downlink shared channel, system information (SIB), an RRC message, a MAC CE, and the like, and outputs the downlink data and the like to the transmitter 210. The higher layer processing unit 206 can include, in the higher layer signaling, some or all of the configuration information related to the grant free access and parameters indicating setup and/or release of the grant free access. The higher layer processing unit 206 may generate a dedicated SIB for notifying of the configuration information related to the grant free access.

The higher layer processing unit 206 maps the multiple access resources to the terminal apparatuses 20 supporting the grant free access. The base station apparatus 10 may hold a lookup table of configuration parameters for the multi-access signature resource. The higher layer processing unit 206 allocates each configuration parameter to the terminal apparatuses 20. The higher layer processing unit 206 uses the multi-access signature resource to generate configuration information related to the grant free access for each terminal apparatus. The higher layer processing unit 206 generates a downlink shared channel including a portion or all of the configuration information related to the grant free access for each terminal apparatus. The higher layer processing unit 206 outputs, to the controller 208/transmitter 210, the configuration information related to the grant free access.

The higher layer processing unit 206 configures a UE ID for each terminal apparatus and notifies the terminal apparatus of the UE ID. As the UE ID, a Cell Radio Network Temporary Identifier (RNTI) can be used. The UE ID is used for the scrambling of the CRC added to the downlink control channel and the downlink shared channel. The UE ID is used for scrambling of the CRC added to the uplink shared channel. The UE ID is used to generate an uplink reference signal sequence. The higher layer processing unit 206 may configure a SPS/grant free access-specific UE ID. The higher layer processing unit 206 may configure the UE ID separately depending on whether or not the terminal apparatus supports the grant free access. For example, in a case that the downlink physical channel is transmitted in the scheduled access and the uplink physical channel is transmitted in the grant free access, the UE ID for the downlink physical channel may be configured separately from the UE ID for the downlink physical channel. The higher layer processing unit 206 outputs the configuration information related to the UE ID to the transmitter 210/controller 208/receiver 204.

The higher layer processing unit 206 determines the coding rate, the modulation scheme (or MCS), and the transmit power for the physical channels (physical downlink shared channel, physical uplink shared channel, and the like). The higher layer processing unit 206 outputs the coding rate/modulation scheme/transmit power to the transmitter 210/controller 208/receiver 204. The higher layer processing unit 206 can include the coding rate/modulation scheme/transmit power in higher layer signaling.

In a case that downlink data to be transmitted is generated, the transmitter 210 transmits the physical downlink shared channel. In a case that the transmitter 210 is transmitting a resource for data transmission by DL Grant, the transmitter 210 may transmit the physical downlink shared channel with the scheduled access, and transmit the physical downlink shared channel of the SPS in a case that the SPS is activated. The transmitter 210 generates the physical downlink shared channel and the demodulation reference signal/control signal associated with the physical downlink shared channel in accordance with the configuration related to the scheduled access/SPS and input from the controller 208.

The coding unit 2100 codes the downlink data input from the higher layer processing unit 206 by using the predetermined coding scheme/coding scheme configured by the controller 208 (the coding includes repetitions). The coding scheme may involve application of convolutional coding, turbo coding, Low Density Parity Check (LDPC) coding, Polar coding, and the like. The LDPC code may be used for data transmission, whereas the Polar code may be used for transmission of the control information. Different error correction coding may be used depending on the downlink channel to be used. Different error correction coding may be used depending on the size of the data or control information to be transmitted. For example, the convolution code may be used in a case that the data size is smaller than a prescribed value, and otherwise the correction coding described above may be used. For the coding described above, in addition to a coding rate of 1/3, a mother code such as a low coding rate of 1/6 or 1/12 may be used. In a case that a coding rate higher than the mother code is used, the coding rate used for data transmission may be achieved by rate matching (puncturing). The modulation unit 2102 modulates coded bits input from the coding unit 2100, in compliance with a modulation scheme notified in the downlink control information or a modulation scheme predetermined for each channel, such as BPSK, QPSK, 16QAM, 64QAM, or 256QAM (the modulation scheme may include R/2 shift BPSK or R/4 shift QPSK).

The multiple access processing unit 2106 performs signal conversion such that the base station apparatus 10 can achieve signal detection even in a case that multiple data are multiplexed on a sequence output from the modulation unit 2102 in accordance with multi-access signature resource input from the controller 208. In a case that the multi-access signature resource is configured as spreading, multiplication by the spreading code sequence is performed according to the configuration of the spreading code sequence. Note that, in a case that interleaving is configured as a multi-access signature resource in the multiple access processing unit 2106, the multiple access processing unit 2106 can be replaced with the interleaving unit. The interleaving unit performs interleaving processing on the sequence output from the modulation unit 2102 in accordance with the configuration of the interleaving pattern input from the controller 208. In a case that code spreading and interleaving are configured as a multi-access signature resource, the multiple access processing unit 2106 of the transmitter 210 performs spreading processing and interleaving. A similar operation is performed even in a case that any other multi-access signature resource is applied, and the sparse code or the like may be applied.

In a case that the OFDM signal waveform is used, the multiple access processing unit 2106 inputs the multiple-access-processed signal to the multiplexing unit 2108. The downlink reference signal generation unit 2112 generates a demodulation reference signal in accordance with the configuration information about the demodulation reference signal input from the controller 208. The configuration information of the demodulation reference signal/identification signal generates a sequence acquired according to a predetermined rule, based on information such as the number of OFDM symbols notified by the base station apparatus in the downlink control information, the position of OFDM symbol where the DMRS is allocated, the cyclic shift, the diffusion of the time domain.

The multiplexing unit 2108 multiplexes (maps, allocates) the downlink physical channel and the downlink reference signal to resource elements for each transmit antenna port. In a case that the SCMA is used, the multiplexing unit 2108 maps the downlink physical channel to resource elements in accordance with an SCMA resource pattern input from the controller 208.

The IFFT unit 2109 performs the Inverse Fast Fourier Transform (IFFT) on the multiplexed signal to perform a modulation in an OFDM scheme to generate OFDM symbols. The radio transmitting unit 2110 adds CPs to the modulated symbols in the OFDM scheme to generate a baseband digital signal. Furthermore, the radio transmitting unit 2110 converts the baseband digital signal into an analog signal, removes the excess frequency components from the analog signal, converts the signal into a carrier frequency by up-conversion, performs power amplification, and transmits the resultant signal to the terminal apparatus 20 via the transmit antenna 212. The radio transmitting unit 2110 includes a transmit power control function (transmit power controller). The transmit power control follows configuration information about the transmit power input from the controller 208. In a case that FBMC, UF-OFDM, or F-OFDM is applied, filtering is performed on the OFDM symbols in units of subcarriers or sub-bands.

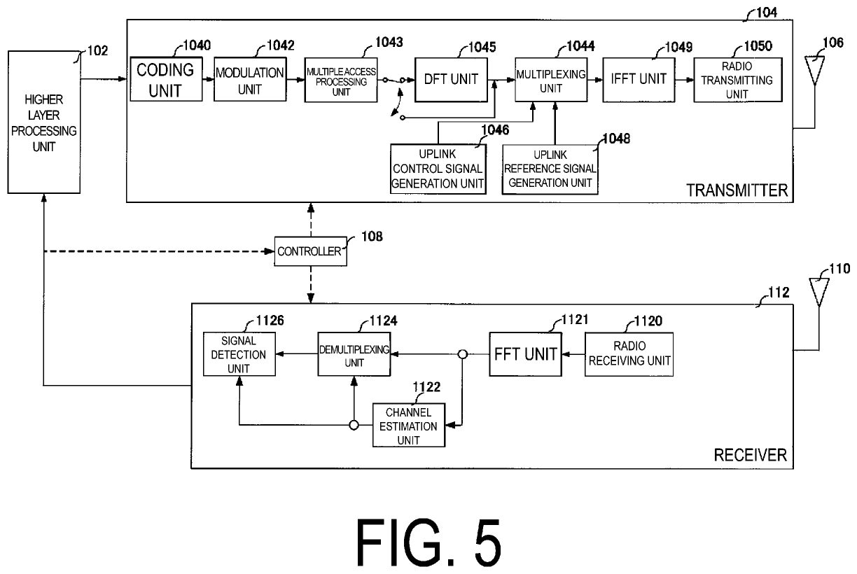

FIG. 5 is a schematic block diagram illustrating a configuration of the terminal apparatus 20 according to the present embodiment. The base station apparatus 10 includes a higher layer processing unit (higher layer processing step) 102, a transmitter (transmitting step) 104, a transmit antenna 106, a controller (control step) 108, a receive antenna 110, and a receiver (receiving step) 112. The transmitter 104 includes a coding unit (coding step) 1040, a modulation unit (modulating step) 1042, a multiple access processing unit (multiple access processing step) 1043, a multiplexing unit (multiplexing step) 1044, a DFT unit (DFT step) 1045, an uplink control signal generation unit (uplink control signal generating step) 1046, an uplink reference signal generation unit (uplink reference signal generating step) 1048, an IFFT unit 1049 (IFFT step), and a radio transmitting unit (radio transmitting step) 1050. The receiver 112 includes a radio receiving unit (radio receiving step) 1120, an FFT unit (FFT step) 1121, a channel estimation unit (channel estimating step) 1122, a demultiplexing unit (demultiplexing step) 1124, and a signal detection unit (signal detecting step) 1126.

The higher layer processing unit 102 performs processing of layers higher than the physical layer, such as the Medium Access Control (MAC) layer, the Packet Data Convergence Protocol (PDCP) layer, the Radio Link Control (RLC) layer, and the Radio Resource Control (RRC) layer. The higher layer processing unit 102 generates information needed to control the transmitter 104 and the receiver 112, and outputs the resultant information to the controller 108. The higher layer processing unit 102 outputs uplink data (e.g., UL-SCH), uplink control information, and the like to the transmitter 104.

The higher layer processing unit 102 transmits information related to the terminal apparatus, such as the function of the terminal apparatus (UE capability), from the base station apparatus 10 (via the transmitter 104). The information related to the terminal apparatus includes information indicating that grant free access or reception/detection/blind decoding of compact DCI is supported, information indicating that reception/detection/blind decoding of the information of repeated DCI format is supported in a case of being transmitted on the PDCCH, and information indicating whether or not the information is supported for each function. The information indicating that the grant free access is supported and the information indicating whether the grant free access is supported on a function-by-function basis may be distinguished from each other based on the transmission mode.

Based on the various types of configuration information input from the higher layer processing unit 102, the controller 108 controls the transmitter 104 and the receiver 112. The controller 108 generates the uplink control information (UCI), based on the configuration information related to the control information input from the higher layer processing unit 102, and outputs the generated uplink control information to the transmitter 104.

The transmitter 104 codes and modulates the uplink control information, the uplink shared channel, and the like input from the higher layer processing unit 102 for each terminal apparatus, to generate a physical uplink control channel, and a physical uplink shared channel. The coding unit 1040 codes the uplink control information, and the uplink shared channel by using the predetermined coding scheme/coding scheme notified in the control information (the coding includes repetitions). The coding scheme may involve application of convolutional coding, turbo coding, Low Density Parity Check (LDPC) coding, Polar coding, and the like. The modulation unit 1042 performs modulation on the coded bits input from the coding unit 1040 by using a predetermined modulation scheme/a modulation scheme notified in the control information such as the BPSK, QPSK, 16QAM, 64QAM, or 256QAM.

The multiple access processing unit 1043 performs signal conversion such that the base station apparatus 10 can achieve signal detection even in a case that multiple pieces of data are multiplexed on a sequence output from the modulation unit 1042 in accordance with multi-access signature resource input from the controller 108. In a case that the multi-access signature resource is configured as spreading, multiplication by the spreading code sequence is performed according to the configuration of the spreading code sequence. The configuration of the spreading code sequence may be associated with other configurations of the grant free access such as the demodulation reference signal/identification signal. Note that the multiple access processing may be performed on the sequence after the DFT processing. Note that, in a case that interleaving is configured as a multi-access signature resource in the multiple access processing unit 1043, the multiple access processing unit 1043 can be replaced with the interleaving unit. The interleaving unit performs interleaving processing on the sequence output from the DFT unit in accordance with the configuration of the interleaving pattern input from the controller 108. In a case that code spreading and interleaving are configured as a multi-access signature resource, the multiple access processing unit 1043 of the transmitter 104 performs spreading processing and interleaving. A similar operation is performed even in a case that any other multi-access signature resource is applied, and the sparse code or the like may be applied.

The multiple access processing unit 1043 inputs the multiple-access-processed signal to the DFT unit 1045 or the multiplexing unit 1044 depending on whether a DFTS-OFDM signal waveform or an OFDM signal waveform is used. In a case that the DFTS-OFDM signal waveform is used, the DFT unit 1045 rearranges multiple-access-processed modulation symbols output from the multiple access processing unit 1043 in parallel and then performs Discrete Fourier Transform (DFT) processing on the rearranged modulation symbols. Here, a zero symbol sequence may be added to the modulation symbols, and the DFT may then be performed to provide a signal waveform in which, instead of a CP, a zero interval is used for a time signal resulting from IFFT. A specific sequence such as Gold sequence or a Zadoff-Chu sequence may be added to the modulation symbols, and the DFT may then be performed to provide a signal waveform in which, instead of a CP, a specific pattern is used for the time signal resulting from the IFFT. In a case that the OFDM signal waveform is used, the DFT is not applied, and thus the multiple-access-processed signal is input to the multiplexing unit 1044. The controller 108 performs control by using a configuration of the zero symbol sequence (the number of bits in the symbol sequence and the like) and a configuration of the specific sequence (sequence seed, sequence length, and the like), the configurations being included in the configuration information related to the grant free access.

The uplink control signal generation unit 1046 adds the CRC to the uplink control information input from the controller 108, to generate a physical uplink control channel. The uplink reference signal generation unit 1048 generates an uplink reference signal.

The multiplexing unit 1044 maps the modulation symbols of each modulated uplink physical channel of the multiple access processing unit 1043 or the DFT unit 1045, the physical uplink control channel, and the uplink reference signal to the resource elements. The multiplexing unit 1044 maps the physical uplink shared channel and the physical uplink control channel to resources allocated to each terminal apparatus.

The IFFT unit 1049 performs Inverse Fast Fourier Transform (IFFT) on the modulation symbols of each multiplexed uplink physical channel to generate OFDM symbols. The radio transmitting unit 1050 adds cyclic prefixes (CPs) to the OFDM symbols to generate a baseband digital signal. Furthermore, the radio transmitting unit 1050 converts the digital signal into an analog signal, removes excess frequency components from the analog signal by filtering, performs up-conversion to the carrier frequency, performs power amplification, and outputs the resultant signal to the transmit antenna 106 for transmission.

The receiver 112 uses the demodulation reference signal to detect the downlink physical channel transmitted from the base station apparatus 10. The receiver 112 detects the downlink physical channel, based on the configuration information notified by the base station apparatus on the control information (such as DCI, RRC, SIB). Here, the receiver 112 performs blind decoding on the search space included in the PDCCH on the candidate that is predetermined or notified by higher layer control information (RRC signaling). As a result of blind decoding, the receiver 112 detects the DCI by using a CRC scrambled with a C-RNTI, a CS-RNTI, an INT-RNTI (both of the downlink and the uplink may be present), or other RNTI. The blind decoding may be performed by the signal detection unit 1126 in the receiver 112, or a control signal detection unit may be separately included although not illustrated in the drawing, and the blind decoding may be performed by the control signal detection unit.

The radio receiving unit 1120 converts, by down-conversion, an uplink signal received through the receive antenna 110 into a baseband signal, removes unnecessary frequency components from the baseband signal, controls the amplification level in such a manner as to suitably maintain a signal level, performs orthogonal demodulation based on an in-phase component and an orthogonal component of the received signal, and converts the resulting orthogonally-demodulated analog signal into a digital signal. The radio receiving unit 1120 removes a part corresponding to the CP from the converted digital signal. The FFT unit 1121 performs Fast Fourier Transform (FFT) on the signal from which the CPs have been removed, and extracts a signal in the frequency domain.

The channel estimation unit 1122 uses the demodulation reference signal to perform channel estimation for signal detection for the downlink physical channel. The channel estimation unit 1122 receives as inputs, from the controller 108, the resources to which the demodulation reference signal are mapped and the demodulation reference signal sequence allocated to each terminal apparatus. The channel estimation unit 1122 uses the demodulation reference signal sequence to measure the channel state between the base station apparatus 10 and the terminal apparatus 20. The demultiplexing unit 1124 extracts the signal in the frequency domain input from the radio receiving unit 1120 (the signal includes signals from multiple terminal apparatuses 20). The signal detection unit 1126 uses the channel estimation result and the signal in the frequency domain input from the demultiplexing unit 1124 to detect a signal of downlink data (uplink physical channel).

The higher layer processing unit 102 acquires, from the signal detection unit 1126, downlink data (bit sequence resulting from hard decision). The higher layer processing unit 102 performs descrambling (exclusive-OR operation) on the CRC included in the decoded downlink data for each terminal apparatus, by using the UE ID (RNTI) allocated to each terminal. In a case that no error is found in the downlink data as a result of the descrambling error detection, the higher layer processing unit 102 determines that the downlink data has been correctly received. Note that the signal detection unit 1126 may include a control information detection unit configured to detect control information such as downlink control information, for example, a DCI format.

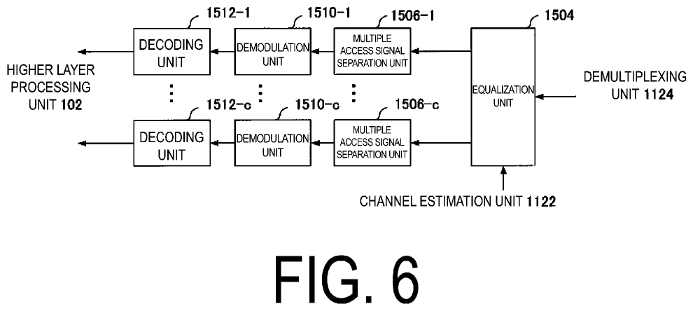

FIG. 6 is a diagram illustrating an example of the signal detection unit according to the present embodiment. The signal detection unit 1126 includes an equalization unit 1504, multiple access signal separation units 1506-1 to 1506-c, demodulation units 1510-1 to 1510-c, and decoding units 1512-1 to 1512-c.

The equalization unit 1504 generates an equalization weight based on the MMSE standard, from the frequency response input from the channel estimation unit 1122. Here, MRC and ZF may be used for the equalization processing. The equalization unit 1504 multiplies the equalization weight by the signal in the frequency domain input from the demultiplexing unit 1124, and extracts the signal in the frequency domain. The equalization unit 1504 outputs the equalized signal in the frequency domain to the multiple access signal separation units 1506-1 to 1506-c. c is one or greater, and is the number of signals received in the same subframe, the same slot, and the same OFDM symbols, such as PUSCH and PUCCH. Reception of other downlink channels may be considered as reception of the same timing.

The multiple access signal separation units 1506-1 to 1506-c separates the signal multiplexed by the multi-access signature resource from the signal in the time domain (multiple access signal separation processing). For example, in a case that code spreading is used as a multi-access signature resource, each of the multiple access signal separation units 1506-1 to 1506-c performs inverse spreading processing by using the spreading code sequence that has been used. Note that, in a case that interleaving is applied as a multi-access signature resource, de-interleaving is performed on the signal in the time domain (deinterleaving unit).

The demodulation units 1510-1 to 1510-c receive as an input, from the controller 108, pre-notified or predetermined information about the modulation scheme. Based on the information about the modulation scheme, the demodulation units 1510-1 to 1510-c perform demodulation processing on the separated multiple access signal, and outputs a Log Likelihood Ratio (LLR) of the bit sequence.

The decoding units 1512-1 to 1512-c receives as an input, from the controller 108, pre-notified or predetermined information about the coding rate. The decoding units 1512-1 to 1512-c perform decoding processing on the LLR sequences output from the demodulation units 1510-1 to 1510-c. In order to perform cancellation processing such as a Successive Interference Canceller (SIC) or turbo equalization, the decoding units 1512-1 to 1512-c may generate a replica from external LLRs or post LLRs output from the decoding units. A difference between the external LLR and the post LLR is whether to subtract, from the decoded LLR, the pre LLR input to each of the decoding units 1512-1 to 1512-c.

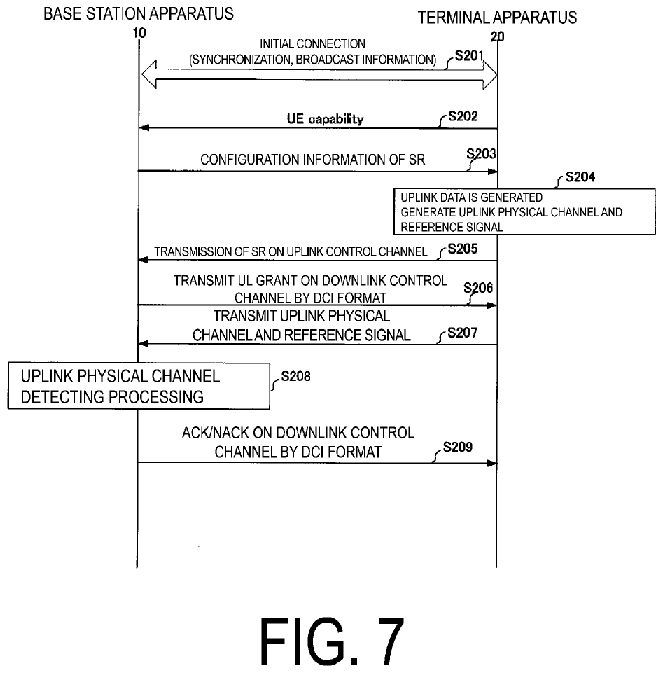

FIG. 7 is a diagram illustrating an example of a sequence chart for a conventional uplink data transmission. The base station apparatus 10 periodically transmits a synchronization signal and a broadcast channel in accordance with a prescribed radio frame format in the downlink. The terminal apparatus 20 performs an initial connection by using the synchronization signal, the broadcast channel, and the like (S201). The terminal apparatus 20 performs frame synchronization and symbol synchronization in the downlink by using the synchronization signal. In a case that the broadcast channel includes the configuration information related to the grant free access, the terminal apparatus 20 acquires the configuration related to the grant free access in the connected cell. The base station apparatus 10 can notify each terminal apparatus 20 of the UE ID in the initial connection.

The terminal apparatus 20 transmits the UE Capability (S202). The base station apparatus 10 can identify, by using the UE Capability, whether the terminal apparatus 20 supports grant free access, whether the terminal apparatus 20 supports URLLC data transmission, whether the terminal apparatus 20 supports eMBB data transmission, whether the terminal apparatus 20 supports multiple types of SR transmission, whether the terminal apparatus 20 supports a data transmission using a different MCS table, and whether the terminal apparatus 20 supports detection of Compact DCI with a smaller number of bits than DCI format 0_0 and 0_1. Note that in S201 to S203, the terminal apparatus 20 can transmit the physical random access channel to acquire resources for uplink synchronization and an RRC connection request.

The base station apparatus 10 transmits the configuration information of the scheduling request (SR) to request radio resources for the uplink data transmission to each of the terminal apparatuses 20 by using the RRC messages, the SIB, or the like (S203). At this time, configuration information related to Compact DCI and grant free access may be included in the RRC message and the SIB. The configuration information related to the grant free access may include the allocation of the multi-access signature resource.

In a case that the uplink data occurs, the terminal apparatus 20 generates a signal of SR (S204). Here, the generation of the uplink data may be the higher layer providing a transport block for the data. The terminal apparatus 20 transmits the signal of SR on the uplink control channel (S205). The base station apparatus 10 transmits the UL Grant in the DCI format on the downlink control channel to the terminal apparatus 20 (S206). The terminal apparatus 20 transmits the uplink physical channel and the demodulation reference signal (initial transmission) (S207). The physical channel used for the data transmission may be a case of transmission based on UL Grant of dynamic scheduling and a case of transmission based on grant free access/SPS, and the terminal apparatus 20 may perform transmission using the resources that can be used in the data transmission timing (slot or OFDM symbols). The base station apparatus 10 performs processing of detecting the uplink physical channel transmitted by the terminal apparatus 20 (S208). Based on the result of the error detection, the base station apparatus 10 transmits the ACK/NACK to the terminal apparatus 20 by using the DCI format on the downlink control channel (S209). In S208, in a case that no errors are detected, the base station apparatus 10 determines to have correctly completed the reception of the uplink data received and transmits the ACK. On the other hand, in a case that an error is detected in S208, the base station apparatus 10 determines to have incorrectly received the uplink data received, and transmits the NACK.

Here, the notification of ACK/NACK for uplink data transmission in the DCI format uses the HARQ process ID and the NDI in the DCI format used in the uplink grant. Specifically, in a case that the DCI format including the HARQ process ID by which data has been transmitted is detected, in a case that the NDI is changed from the NDI value at the detection of the DCI format of the previous same HARQ process ID (in a case of being toggled for 1 bit), the notification is ACK (in FIG. 7, in a case that the DCIs detected by S206 and S209 indicate the same HARQ process ID and the NDI is toggled, the notification is ACK), and in a case that the detected DCI format is the uplink grant for new data transmission, and the NDI is the same (in a case that the NDI value is not toggled), the notification is NACK (in FIG. 7, in a case that the DCIs detected by S206 and S209 indicate the same HARQ process ID and NDI is not toggled, the notification is NACK). In a case that the DCI format of the NACK is detected, the detected DCI format is an uplink grant for retransmission data transmission.

Note that the DCI format for notifying of the uplink grant in S206 may include the information of the frequency resource (resource block, resource block group, subcarrier) to be used for uplink data transmission, a relative time from the slot n in which the DCI format has been detected in the PDCCH to the uplink data transmission timing (e.g. in a case that the relative time is k, the slot n+k is the uplink data transmission timing), the number of OFDM symbols to be used in the slot of the uplink data transmission timing, the starting positions, and the number of continuous OFDM symbols. The uplink grant may notify of data transmission of multiple slots, and in a case that the relative time indicating the uplink data transmission timing is k, the uplink grant includes information of n′ in a case that the data transmission is allowed from the slot n+k to the slot n+k+n′.

In a case that the terminal apparatus detects the uplink grant by the blind decoding of the PDCCH, the terminal apparatus transmits the uplink data at the uplink data transmission timing specified by the uplink grant. Here, the uplink grant includes the HARQ process number (e.g., four bits), and the terminal apparatus performs the data transmission of the uplink grant corresponding to the HARQ process number specified by the uplink grant.

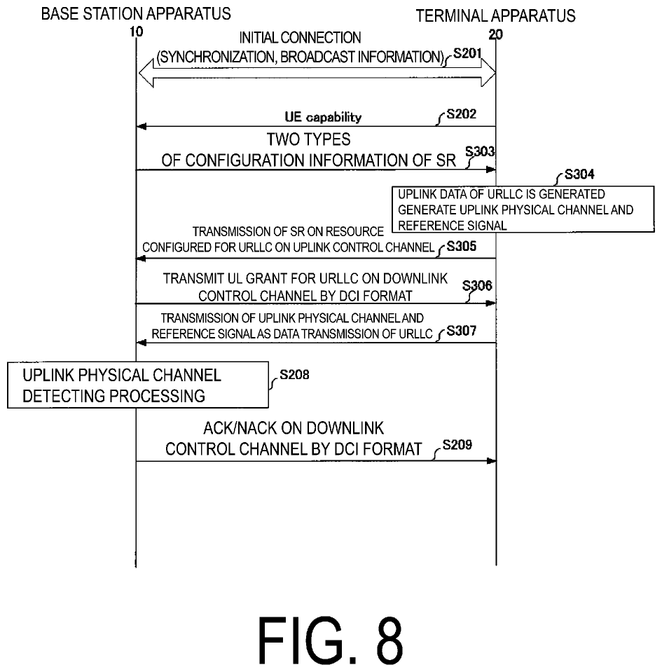

FIG. 8 is a diagram illustrating an example of a sequence chart for data transmission of the uplink according to the first embodiment. The differences between FIG. 8 and FIG. 7 are S303 to 307 and the processing of differences from FIG. 7 will be described. The terminal apparatus uses the UE Capability in S202 to notify that the URLLC and eMBB data transmission is supported. Here, the difference of data between the eMBB and the URLLC may be a case that the uplink grant is received in DCI format 0_0/0_1 and a case that the uplink grant is received in the compact DCI including the number of control information bits less than DCI format 0_0/0_1, may be a case of use of a table having a higher minimum frequency utilization efficiency (Spectral efficiency) of an MCS table used for data transmission or a case of use of a table having a lower minimum frequency utilization efficiency, may be a case that the number of entries of MCS tables available for data transmission is 32 (5 bits) and a case that the number of entries of MCS tables available for data transmission is 16 or less (4 bits or less), may be a case of the dynamic scheduling and a case of the SPS/Configured grant/grant free access, may be a case that the number of HARQ processes is 16 and a case that the number of HARQ processes is 4, may be a case that the number of repetitions of data transmission is less than or equal to a prescribed value (e.g., less than or equal to 1) and a case that the number of repetitions is greater than a prescribed value, may be a case that the priority of the Logical CHannel (LCH) is low and a case that the priority is high, or may be determined by a QoS Class Indicator (QCI).

The base station apparatus 10 transmits two types of the configuration information of the scheduling request (SR) to request radio resources for the uplink data transmission to each of the terminal apparatuses 20 by using the RRC messages, the SIB, or the like (S303). Here, the SR configuration can configure multiple of the PUCCH format (0 or 1) used, the resource of the PUCCH, the period of the transmission prohibit timer after transmission of the SR, the maximum number of SR transmissions, the transmittable periodicity of SR, and the offset of SR, but corresponds to multiple serving cells, BWPs, and PUCCH formats to be used, and it is not possible to determine whether the uplink data is eMBB or URLLC. Therefore, in S303, two types of the configuration for the SR for the uplink eMBB and the configuration for the SR for the uplink URLLC are notified. Note that the base station apparatus may notify of three or more types of SR configuration information, including SR or the like for the mMTC.

An example of a method of notifying of the SR for the eMBB and the URLLC may include specifying one or more configurations (one or more sets) as a transmission configuration for the SR for the URLLC by a higher layer signal such as RRC, in multiple configured transmission configurations of the SR (PUCCH resource, PUCCH format, an SR transmittable periodicity and offset, a period of a transmission prohibit timer after transmission of SR, the maximum number of SR transmissions as one set). One or more IDs may be specified as a transmission configuration for the SR for the URLLC by an ID (SchedulingRequestId) indicating a set of a period of a transmission prohibit timer after transmission of SR and the maximum number of SR transmissions in a higher layer signal such as RRC. The one or more IDs may be specified as a transmission configuration for the SR for the URLLC by an ID (SchedulingRequestResourceId) indicating a set of the PUCCH resource, the PUCCH format, and an SR transmittable periodicity and offset in a higher layer signal such as RRC.

As described above, in a case that a transmission configuration of the SR for the URLLC is notified by using a set of transmission configurations for the SR or any ID, and multiple sets or multiple IDs are specified as the transmission configuration of the SR for the URLLC, a prescribed number of sets or IDs may be configured as valid configuration, and an invalid configuration may be switched between validation and invalidation by switching the BWP or activating/deactivating the serving cell. Specifically, in a case that the base station apparatus specifies three sets or IDs as the transmission configurations for the SR for the URLLC, and validates only one of the transmission configurations for the SR for the URLLC, the transmission of the SR in the valid transmission configuration for the SR for the URLLC is a scheduling request for the URLLC, and the SR transmissions by other two specified transmission configurations of the SR for the URLLC are scheduling requests for the eMBB. This is because even in a case that transmission configurations for the SR are performed, associated BWPs may be disabled. Thus, in a case that multiple sets or IDs are specified as the transmission configuration of the SR for the URLLC, priority ranking information may also be added, and a set or an ID associated with an active BWP having a higher priority ranking may be configured as the transmission configuration of the SR for the URLLC. The configuration of the priority ranking may be not configured in a unit of configuration information of the SR, but may be configured in a unit of a type of the BWP, the serving cell, the PCell/PSCell/SCell, or the like (e.g., PCell prioritized), a type of the cell group (CG) (e.g., MCG prioritized), SUL or not (e.g., SUL prioritized), the subcarrier spacing configured (e.g., the larger subcarrier spacing is prioritized), and the PUCCH format configured. Note that four BWPs can be configured in one serving cell, and only one BWP can be activated.

In this way, in a case that the transmission configuration of the SR for the URLLC is specified by a set of multiple transmission configurations of the SR or multiple IDs, the transmission configuration of the SR for the URLLC can also be switched in a case that the available band is changed due to switching of the active BWP by a timer or DCI or deactivation of the serving cell.

Next, in FIG. 8, in a case that the uplink data for the URLLC is generated, the terminal apparatus 20 generates a signal for the SR in the specified PUCCH format, based on the transmission configuration of the SR for the URLLC (S304). Here, the generation of the uplink data of the URLLC may be the higher layer providing a transport block for the data of the URLLC. The terminal apparatus 20 transmits the signal of SR on the uplink control channel, based on the transmission configuration of the SR for the URLLC (S305). In a case that the base station apparatus 10 detects the SR, based on the transmission configuration of the SR for the URLLC, the base station apparatus 10 transmits, on the downlink control channel, the UL Grant for the URLLC by the DCI format to the terminal apparatus 20 (S306). Here, the UL Grant for the URLLC may mean using the Compact DCI, may mean repeatedly transmitting the same DCI, or may mean being different from the data transmission of the eMBB by either the scheduling information indicated by the UL Grant, the method of specifying the MCS, and the method for specifying the HARQ process number. The terminal apparatus transmits the uplink physical channel and the demodulation reference signal (initial transmission), based on the UL Grant for the URLLC (S307). The subsequent processing is omitted since it is the same as in FIG. 7.

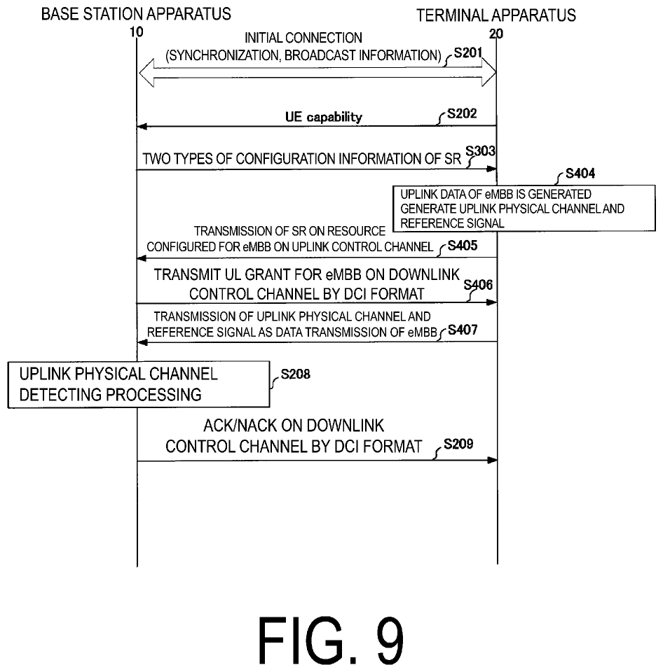

FIG. 9 is a diagram illustrating an example of a sequence chart for data transmission of the uplink according to the first embodiment. The differences between FIG. 9 and FIG. 8 are S404 to 407 and the processing of differences from FIG. 8 will be described. In S303, the terminal apparatus receives two types of SR configuration information. In a case that the uplink data for the eMBB is generated, the terminal apparatus 20 generates a signal for the SR in the specified PUCCH format, based on the transmission configuration of the SR for the eMBB (S404). Here, the generation of the uplink data of the eMBB may be the higher layer providing a transport block for the data of the eMBB. The terminal apparatus 20 transmits the signal of SR on the uplink control channel, based on the transmission configuration of the SR for the eMBB (S405). In a case that the base station apparatus 10 detects the SR, based on the transmission configuration of the SR for the eMBB, the base station apparatus 10 transmits, on the downlink control channel, the UL Grant for the eMBB by the DCI format to the terminal apparatus 20 (S406).

Here, the UL Grant for the eMBB may mean using DCI format 0_0 or 0_1, may mean not repeatedly transmitting the same DCI, or may mean being different from the data transmission of the URLLC by either the scheduling information indicated by the UL Grant, the method of specifying the MCS, and the method for specifying the HARQ process number. The terminal apparatus transmits the uplink physical channel and the demodulation reference signal (initial transmission), based on the UL Grant for the eMBB (S407). The subsequent processing is omitted since it is the same as in FIG. 7 and FIG. 8.

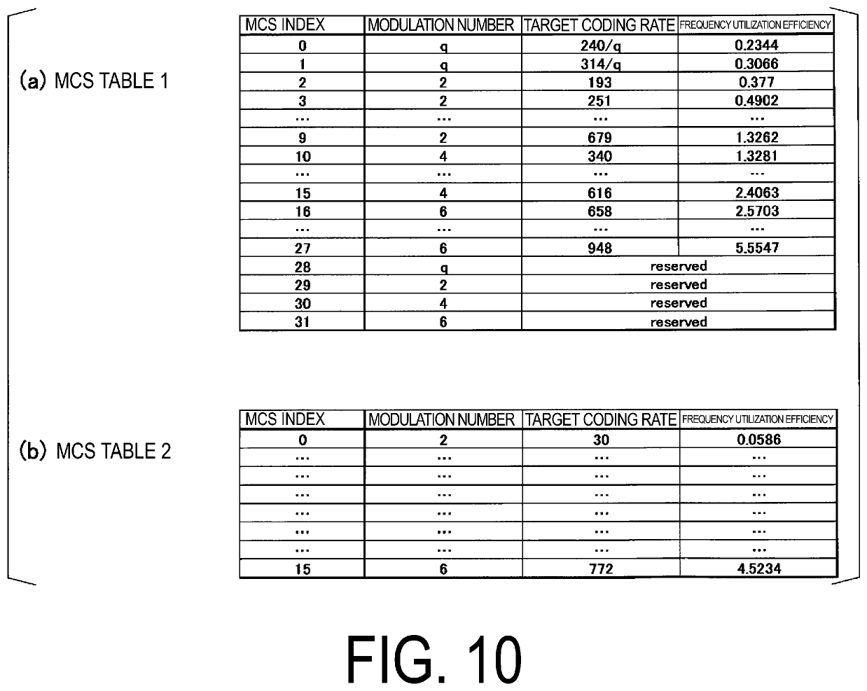

Note that, in a case that the MCS tables used are different in the data transmission of the eMBB and the data of the URLLC, the processing may be performed as in the example of FIG. 10. FIG. 10 is a diagram illustrating an example of an MCS table for the data transmission of the uplink according to the first embodiment. FIG. 10(a) is an example of a table of MCS for use in the data transmission of the eMBB. There are 32 types of indexes, and indexes 0 and 1 are specified by control information for q=1 (BPSK) and 2 (QPSK). FIG. 10(a) is an example of using the indexes 28 to 31 for retransmission. In the example of FIG. 10(a), the lowest frequency utilization efficiency (Spectral efficiency (SE)) is 0.2344, and the highest frequency utilization efficiency is 5.5547. On the other hand, FIG. 10(b) is an example of a table of MCS for use in the data transmission of the URLLC. In the example of FIG. 10(b), there are 16 types of indexes, but a different value may be used as long as the number of indexes is less than or equal to the number of indexes of the MCS table used for the data transmission of the eMBB. In the example of FIG. 10(b), the lowest frequency utilization efficiency is 0.0586, but a different value may be used as long as the lowest frequency utilization efficiency is lower than the lowest frequency utilization efficiency of the MCS table used for the data transmission of the eMBB. In the example of FIG. 10(b), the highest frequency utilization efficiency is 4.5234, but a different value may be used as long as the maximum frequency utilization efficiency is lower than the highest frequency utilization efficiency of the MCS table used for the data transmission of the eMBB. The used MCS table used in the data transmission of the eMBB may be selected from a table including 64QAM and 256QAM, and the MCS table used in the data transmission of the URLLC may be a table up to 64QAM. The used MCS table used in the data transmission of the eMBB may be selected from a table not including BPSK, and the MCS table used in the data transmission of the URLLC may be a table including BPSK. It is not necessary to satisfy all of the conditions described above, and at least one condition may be satisfied.

In the present embodiment, in a case that the terminal apparatus supports the data transmission of the eMBB and the URLLC in the uplink, the base station apparatus performs the transmission configuration of the SR for the eMBB and the transmission configuration of the SR for the URLLC. In transmitting the SR, the terminal apparatus selects the transmission configuration of the SR to be used by the type of uplink data transmission (eMBB/URLLC). As a result, the base station apparatus can determine whether the uplink data held by the terminal apparatus is eMBB or URLLC by the received SR, and it is possible to schedule in accordance with the type of data. Thus, a low delay and a high reliability requirement of the URLLC in the uplink can be satisfied.

### Second Embodiment

The present embodiment describes a method for dynamically notifying of transmission configuration of an SR for the URLLC. A communication system according to the present embodiment includes the base station apparatus 10 and the terminal apparatus 20 illustrated with reference to FIG. 3, FIG. 4, FIG. 5, and FIG. 6. Differences from/additions to the first embodiment will be mainly described below.

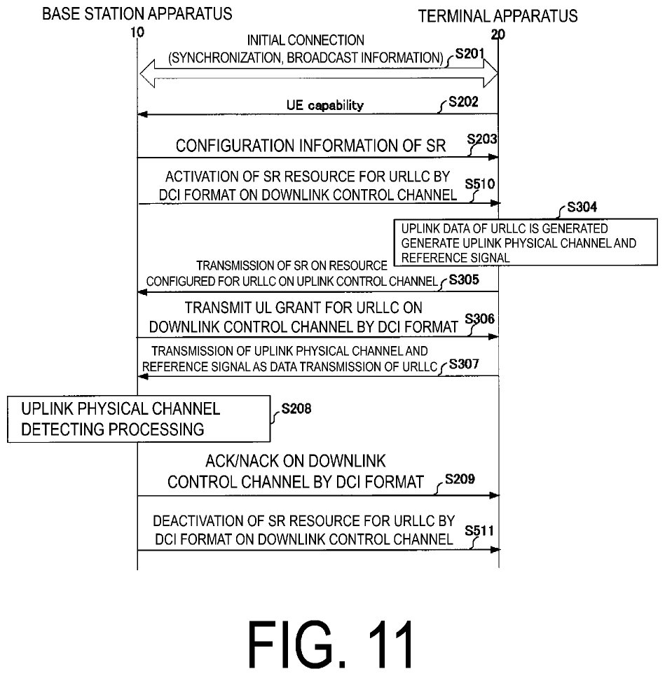

FIG. 11 is a diagram illustrating an example of a sequence chart for data transmission of the uplink according to the second embodiment. The differences between FIG. 11 and FIG. 8 are S510 and S511 and the processing of differences from FIG. 8 will be described. The terminal apparatus uses the UE Capability in S202 to notify that the URLLC and eMBB data transmission is supported. The base station apparatus 10 transmits the configuration information of the scheduling request (SR) to request radio resources for the uplink data transmission to each of the terminal apparatuses 20 by using the RRC messages, the SIB, or the like (S203). S203 is similar to the processing of FIG. 7 and notifies of one type of configuration information of the SR. In other words, the transmission configuration of the SR for the eMBB and the transmission configuration of the SR for the URLLC are not present in the configuration information of the SR notified by S203.

The base station apparatus 10 notifies of activation of the SR resource for the URLLC by the DCI format in the PDCCH (S501). Here, the DCI format for activation of the SR resource, similar to grant free access or SPS, may use an existing DCI format (at least one of the formats 0_0 and 0_1), or may use a DCI format different from the existing DCI format. In a case that the SR resource is activated by the existing DCI format, the CRC may be scrambled with a RNTI different from a dynamic scheduling (C-RNTI) such as an SR-RNTI or a grant free access/SPS (CS-RNTI). In a case that the SR resource is activated by the existing DCI format, some fields may be used for the Validation, such as MCS, HARQ process number, RV. The DCI format for activation of the SR resource may include an ID indicating the configuration of the SR notified by the RRC, for example, schedulingRequestResourceId or schedulingRequestID, or the resource may be notified using a field of the frequency domain resource assignment without using these IDs, or may include a transmittable periodicity of SR, a transmission prohibit period after SR transmission, and the maximum number of transmissions of SR.

S304 to S307 and S208 to S209 in FIG. 11 are the same processing as in FIG. 8, and thus descriptions thereof will be omitted. Next, the base station apparatus 10 notifies of deactivation (release) of the SR resource for the URLLC by the DCI format in the PDCCH (S511). In case of detecting the notification in S511, the transmission configuration of the SR for the URLLC is disabled. In the deactivation of the SR resource for the URLLC by the DCI format, the Validation may be performed in the same manner as activation. The DCI format may notify of a change (modification) of the SR resource for the URLLC. The change in the SR resource for the URLLC by the DCI format may be an operation of notifying of an SR resource different from the SR resource for the activated URLLC, releasing the SR resource that was activated prior to the notification of the change in the SR resource, and activating the newly notified SR resource.

In the present embodiment, in a case that the terminal apparatus supports the data transmission of the eMBB and the URLLC in the uplink, the base station apparatus activates the transmission configuration of the SR for the URLLC by the DCI. In transmitting the SR, the terminal apparatus selects the transmission configuration of the SR to be used by the type of uplink data transmission (eMBB/URLLC). As a result, the base station apparatus can determine whether the uplink data held by the terminal apparatus is eMBB or URLLC by the received SR, and it is possible to schedule in accordance with the type of data. Thus, a low delay and a high reliability requirement of the URLLC in the uplink can be satisfied.

### Third Embodiment

The present embodiment describes a method for notifying of a type of data in processing of uplink data transmission. A communication system according to the present embodiment includes the base station apparatus 10 and the terminal apparatus 20 illustrated with reference to FIG. 3, FIG. 4, FIG. 5, and FIG. 6. Differences from/additions to the first embodiment will be mainly described below.

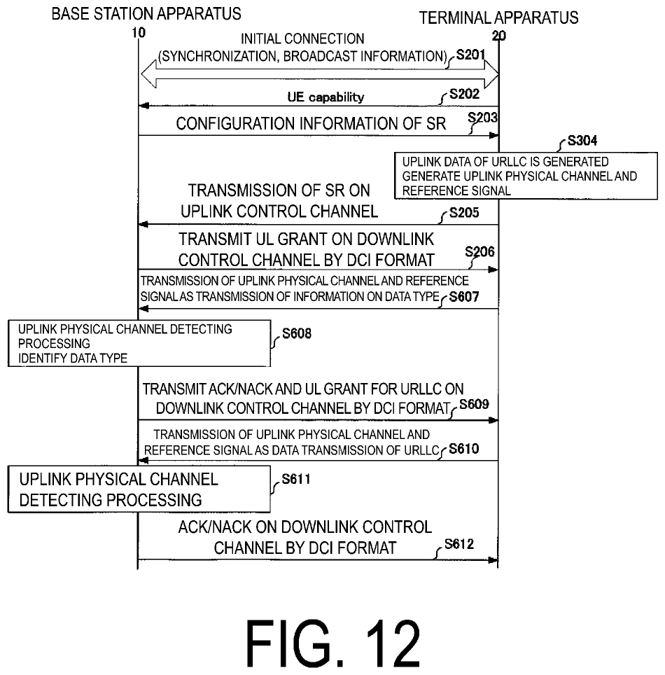

FIG. 12 is a diagram illustrating an example of a sequence chart for data transmission of the uplink according to the third embodiment. The differences between FIG. 12 and FIG. 7 are S304, and S607 to S612, and the processing of differences from FIG. 7 will be described. The terminal apparatus uses the UE Capability in S202 to notify that the URLLC and eMBB data transmission is supported. The base station apparatus 10 transmits the configuration information of the scheduling request (SR) to request radio resources for the uplink data transmission to each of the terminal apparatuses 20 by using the RRC messages, the SIB, or the like (S203). S203 is similar to the processing of FIG. 7 and notifies of one type of configuration information of the SR. In other words, the transmission configuration of the SR for the eMBB and the transmission configuration of the SR for the URLLC are not present in the configuration information of the SR notified by S203.

In a case that the uplink data of the URLLC is generated, the terminal apparatus 20 generates a signal for the SR in the PUCCH format specified in a similar manner as in FIG. 7, because there is only one type of transmission configuration of the SR (S304). Here, the generation of the uplink data of the URLLC may be the higher layer providing a transport block for the data of the URLLC. In S205, the terminal apparatus transmits the SR on the uplink control channel. In S206, the base station apparatus notifies of the uplink grant in a normal DCI format and a normal transmission method on the downlink control channel because the uplink data type is unknown.

After detecting the uplink grant, the terminal apparatus transmits the uplink data type held in the MAC header on the uplink shared channel (PUSCH) (S607). Specifically, the terminal apparatus sets high priority for the data of the URLLC by the logical channel priority (LCH Priority), indicates the URLLC by the QCI, or the like.

The base station apparatus 10 detects the uplink physical channel transmitted by the terminal apparatus 20 and determines that the terminal apparatus has the uplink data of the URLLC by the LCH priority or the QCI included in the MAC header (S608). Furthermore, in a case that the base station apparatus determines that the terminal apparatus has the uplink data of the URLLC, the base station apparatus transmits, on the downlink control channel, an ACK/NACK by the DCI format and an UL grant for the URLLC (S609).

After detecting the UL grant for the URLLC, the terminal apparatus transmits the data of the URLLC and the reference signal on the uplink physical channel (S610). The base station apparatus 10 detects the data of the URLLC transmitted by the terminal apparatus 20 on the uplink physical channel (S611). The base station apparatus transmits an ACK/NACK by the DCI format on the downlink control channel (S609). As described above, a notification that the terminal apparatus has the data of the URLLC to be transmitted in the uplink and a data transmission are realized.

In the present embodiment, in a case that the terminal apparatus supports the data transmission of the eMBB and the URLLC in the uplink, the terminal apparatus notifies of the uplink data transmission type (eMBB/URLLC) by the MAC header. As a result, the base station apparatus can determine whether the uplink data held by the terminal apparatus is eMBB or URLLC by the received information, and it is possible to schedule in accordance with the type of data. Thus, a low delay and a high reliability requirement of the URLLC in the uplink can be satisfied.

Note that as a notification example of the UL Grant for the URLLC of the present specification, the search space, aggregation level, candidates for blind decoding in the search space, CORESET, BWP, serving cell, and the like may be specified by the control information of a higher layer such as RRC, and the DCI may be notified under the specified conditions. Note that while an example of a PUCCH resource is illustrated as the transmission configuration of the SR for the URLLC in the present specification, the traffic for the eMBB and the URLLC may be determined by changing the method for generating a signal of the SR such as a cyclic shift (mₑₛ) used for transmission of the PUCCH.

Note that the embodiments in the present specification may be applied in combination with multiple embodiments, or only each embodiment may be applied.

A program running on an apparatus according to an aspect of the present invention may serve as a program that controls a Central Processing Unit (CPU) and the like to cause a computer to operate in such a manner as to realize the functions of the above-described embodiments according to the present invention. Programs or the information handled by the programs are temporarily read into a volatile memory, such as a Random Access Memory (RAM) while being processed, or stored in a non-volatile memory, such as a flash memory, or a Hard Disk Drive (HDD), and then read by the CPU to be modified or rewritten, as necessary.

Note that the apparatuses in the above-described embodiments may be partially enabled by a computer. In that case, a program for realizing the functions of the embodiments may be recorded on a computer readable recording medium. This configuration may be realized by causing a computer system to read the program recorded on the recording medium for execution. It is assumed that the “computer system” refers to a computer system built into the apparatuses, and the computer system includes an operating system and hardware components such as a peripheral device. The “computer-readable recording medium” may be any of a semiconductor recording medium, an optical recording medium, a magnetic recording medium, and the like.

Moreover, the “computer-readable recording medium” may include a medium that dynamically retains a program for a short period of time, such as a communication line that is used for transmission of the program over a network such as the Internet or over a communication line such as a telephone line, and may also include a medium that retains a program for a fixed period of time, such as a volatile memory within the computer system for functioning as a server or a client in such a case. The above-described program may be one for realizing some of the above-described functions, and also may be one capable of realizing the above-described functions in combination with a program already recorded in a computer system.

Each functional block or various characteristics of the apparatuses used in the above-described embodiments may be implemented or performed on an electric circuit, that is, typically an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may include a digital circuit, or may include an analog circuit. In a case that with advances in semiconductor technology, a circuit integration technology appears that replaces the present integrated circuits, it is also possible to use an integrated circuit based on the technology.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Various modifications are possible within the scope of one aspect of the present invention defined by claims, and embodiments that are made by suitably combining technical means disclosed according to the different embodiments are also included in the technical scope of the present invention. A configuration in which constituent elements, described in the respective embodiments and having mutually the same effects, are substituted for one another is also included in the technical scope of the present invention.

### INDUSTRIAL APPLICABILITY

An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

10 Base station apparatus
20-1 to 20-n1 Terminal apparatus
10a Range within which base station apparatus 10 is connectable to terminal apparatus
102 Higher layer processing unit
104 Transmitter
106 Transmit antenna
108 Controller
110 Receive antenna
112 Receiver
1040 Coding unit
1042 Modulation unit
1043 Multiple access processing unit
1044 Multiplexing unit
1046 Uplink control signal generation unit
1048 Uplink reference signal generation unit
1049 IFFT unit
1050 Radio transmitting unit
1120 Radio receiving unit
1121 FFT unit
1122 Channel estimation unit
1124 Demultiplexing unit
1126 Signal detection unit
1504 Equalization unit
1506-1 to 1506-c Multiple access signal separation unit
1510-1 to 1510-c Demodulation unit
1512-1 to 1512-c Decoding unit
202 Receive antenna
204 Receiver
206 Higher layer processing unit
208 Controller
210 Transmitter
212 Transmit antenna
2100 Coding unit
2102 Modulation unit
2106 Multiple access processing unit
2108 Multiplexing unit
2109 IFFT unit
2110 Radio transmitting unit
2112 Downlink reference signal generation unit
2113 Downlink control signal generation unit
2040 Radio receiving unit
2041 FFT unit
2042 Demultiplexing unit
2043 Channel estimation unit
2044 Signal detection unit
2504 Equalization unit
2506-1 to 2506-u Multiple access signal separation unit
2508-1 to 2508-u IDFT unit
2510-1 to 2510-u Demodulation unit
2512-1 to 2512-u Decoding unit

1. A terminal apparatus for communicating with a base station apparatus, the terminal apparatus comprising:
a control information detection unit configured to detect radio resource control (RRC) information including a configuration of uplink control information; and
a transmitter configured to transmit a scheduling request (SR) for requesting a resource of an uplink shared channel for data transmission, wherein
the configuration of the uplink control information detected by the control information detection unit includes multiple configurations for the SR including at least a first resource used to transmit the SR for transmission of a first transport block and a second resource used to transmit the SR for transmission of a second transport block,
a first MCS index table used for the transmission of the first transport block can specify a combination of a modulation order and a coding rate with a frequency utilization efficiency lower than a lowest frequency utilization efficiency usable in a second MCS index table used for the transmission of the second transport block, and
the transmitter transmits the SR in the first resource in a case that a higher layer provides the first transport block, and transmits the SR in the second resource in a case that the higher layer provides the second transport block.

2. The terminal apparatus according to claim 1, wherein
the first resource used to transmit the SR for the transmission of the first transport block is notified by using an ID indicating a set of a physical uplink control channel (PUCCH) resource, a PUCCH format, and an SR transmittable periodicity and offset.

3. The terminal apparatus according to claim 1, wherein
the first resource used to transmit the SR for the transmission of the first transport block is notified by using an ID indicating a set of a period of a transmission prohibit timer after transmission of the SR, and a maximum number of the SR transmissions.

4. The terminal apparatus according to claim 1, wherein
the transmitter is configured with multiple bandwidth parts (BWPs) or multiple serving cells, and
in a case that a plurality of the first resources used to transmit the SR for the transmission of the first transport block are configured, a first resource of the plurality of the first resources used to transmit the scheduling request of an active BWP or an active serving cell is used.

5. The terminal apparatus according to claim 4, wherein
in a case that the plurality of the first resources used to transmit the SR for the transmission of the first transport block are configured, a priority of the first resource used to transmit the SR is also notified.

6. The terminal apparatus according to claim 1, wherein
in the transmission of the first transport block, at least one of following conditions is satisfied: an uplink grant is notified in a DCI format different from that for the transmission of the second transport block; an MCS table different from that for the transmission of the second transport block is used; an MCS having a lower frequency utilization efficiency than an MCS for the transmission of the second transport block can be used; the number of hybrid automatic repeat request (HARQ) processes that can be used is less than that for the transmission of the second transport block; and the number of repetitions of an identical data is greater than that for the transmission of the second transport block.

7. The terminal apparatus according to claim 1, wherein
the first resource used to transmit the SR for the transmission of the first transport block is configured by a DCI format.
